(19) United States
(12) Patent Application Publication
(10) Pub. No.: US 2013/0218442 A1
(43) Pub. Date: Aug. 22, 2013

(54) CONTROL DEVICE AND CONTROL METHOD FOR HYBRID VEHICLE

(71) Applicants: Kazuya Miyaji, Okazaki-shi (JP); Toshikazu Kato, Toyota-shi (JP)

(72) Inventors: Kazuya Miyaji, Okazaki-shi (JP); Toshikazu Kato, Toyota-shi (JP)

(21) Appl. No.: 13/769,617

(22) Filed: Feb. 18, 2013

(30) Foreign Application Priority Data
Feb. 20, 2012 (JP) 2012-034052

(51) Int. Cl. F02D 41/06

(52) U.S. Cl. CPC F02D 41/062; Y10S 903/902
USPC 701/108; 701/113; 903/902; 180/65.28

(57) ABSTRACT

When an engine is being cranked, a maximum slope value is set on the basis of a slope value of an output voltage of an air-fuel ratio sensor, a normalized maximum slope value is set by normalizing the set maximum slope value, and a learned value of a responsiveness of the air-fuel ratio sensor is calculated using the set normalized maximum slope value.

The disclosure of Japanese Patent Application No. 2012-034052 filed on Feb. 20, 2012 including the specification, drawings and abstract, is incorporated herein by reference in its entirety.

### BACKGROUND OF THE INVENTION

1. Field of the Invention

The invention relates to a control device and control method for a hybrid vehicle.

2. Description of Related Art

In an existing art, there is suggested a control device for a hybrid vehicle of this type, which executes air-fuel ratio feedback control over an engine on the basis of an output value of an air-fuel ratio sensor and, when the output value of the air-fuel ratio sensor at the time of a lapse of a predetermined period of time from a restart after a temporary stop of the engine is in a lean region, detects a response delay abnormality of the air-fuel ratio sensor and does not permit intermittent operation of the engine (for example, see Japanese Patent Application Publication No. 2008-143482 (JP 2008-143482 A)). In this hybrid vehicle, deterioration of exhaust emissions at the time of a restart is inhibited through such control.

In the above-described control device for a hybrid vehicle, for example, when the operation of the engine stops before a lapse of the predetermined period of time from a restart of the engine, it is not possible to determine whether there is a response delay abnormality in the air-fuel ratio sensor. In addition, in the above-described control device for a hybrid vehicle, only a response delay abnormality of the air-fuel ratio sensor is detected, and the responsiveness itself is not grasped (learned). Thus, it is an object to constructing a method of learning the responsiveness of the air-fuel ratio sensor and providing a relatively large number of opportunities to learn the responsiveness.

### SUMMARY OF THE INVENTION

The invention allows a hybrid vehicle to construct a method of learning the responsiveness of an air-fuel ratio sensor and providing a relatively large number of opportunities to team the responsiveness.

An aspect of the invention provides a control device for a hybrid vehicle that includes: an engine; a motor that cranks the engine; a battery that supplies electric power to the motor; and an air-fuel ratio sensor that is attached to an exhaust system of the engine and that changes its output value on the basis of an air-fuel ratio. The control device includes a control unit that is configured to learn a responsiveness of the air-fuel ratio sensor using a slope of the output value of the air-fuel ratio sensor at the time when the motor is cranking the engine.

In the control device, the control unit is configured to learn the responsiveness of the air-fuel ratio sensor using the slops of the output value of the air-fuel ratio sensor at the time when the motor is cranking the engine. Usually, when the engine is being cranked, a new air (fresh air) is introduced into an intake pipe, so the air-fuel ratio varies toward a lean side. Then, the output value of the air-fuel ratio sensor varies on the basis of the variation in the air-fuel ratio. Thus, it is possible to learn the responsiveness of the air-fuel ratio sensor using the slope of the output value of the air-fuel ratio sensor at the time when the engine is being cranked. A hybrid vehicle travels while intermittently operating the engine from a system start to a system stop. Therefore, by learning the responsiveness of the air-fuel ratio sensor using the slope of the output value of the-air-fuel ratio sensor at the time when the engine is being cranked, it is presumably possible to learn with a larger amount of opportunities as compared with a configuration that learns after a lapse of a predetermined period of time from a start of the engine. The “air-fuel ratio sensor” may be a sensor that substantially linearly increases its output value as the air-fuel ratio increases.

In the control device according to the aspect of the invention, the control unit may be configured to normalize a cranking maximum slope value that is a maximum value of the slope of the output value of the air-fuel ratio sensor at the time when the motor is cranking the engine using at least one of the output value of the air-fuel ratio sensor at the time-when the motor starts cranking the engine, an atmospheric pressure and a throttle opening degree, and the control unit may be configured to compute a learned value of the responsiveness of the air-fuel ratio sensor using the normalized cranking maximum slope value. Here, “normalizing” may be performed by converting the cranking maximum slope value to a cranking maximum slope value at the time when the output value of the air-fuel ratio sensor at the time when the motor starts cranking the engine is a predetermined air-fuel ratio, converting the cranking maximum slope value to a cranking maximum slope value at the time when the atmospheric pressure is a predetermined atmospheric pressure or converting the cranking maximum slope value to a cranking maximum slope value at the time when the throttle opening degree is a predetermined opening degree.

In the control device that is configured to compute the learned value of the responsiveness of the air-fuel ratio sensor using the normalized cranking maximum slope value, the control unit may be configured to compute the sum of a value, obtained by multiplying the computed normalized cranking maximum slope value by a reflecting coefficient larger than 0 and smaller than 1, and a value, obtained by multiplying a previous learned value of the responsiveness of the air-fuel ratio sensor by a value obtained by subtracting the reflecting coefficient from 1, as the learned value of the responsiveness of the air-fuel ratio sensor. Here, the “reflecting coefficient” may be a value that is larger than 0 and smaller than 1.

In the control device according to the aspect of the invention, the control unit may be configured not to learn the responsiveness of the air-fuel ratio sensor when a power of the motor is limited to below a threshold or when a rising of a rotation speed of the engine at the time when the motor is cranking the engine is slower than a threshold.

In the control device according to the aspect of the invention, after a start of the engine, the control unit may be configured to set timing at which air-fuel ratio feedback control is started so as to be delayed as the responsiveness of the air-fuel ratio sensor decreases. In the control device according to this aspect, the control unit may be configured to start air-fuel ratio feedback control after a lapse of a predetermined period of time from a start of the engine and when the output value of the air-fuel ratio sensor has reached a threshold that is determined so as to be richer than a target air-fuel ratio and that approaches the target air-fuel ratio as the responsiveness of the air-fuel ratio sensor decreases or when the output value of the air-fuel ratio sensor has reached a value that is closer to a stoichiometric air-fuel ratio than the threshold.

Alternatively, in the control device according to the aspect of the invention, the control unit may be configured to set a limit value of an integral term in air-fuel ratio feedback control so as to reduce as the responsiveness of the air-fuel ratio sensor decreases.

Another aspect of the invention provides a control method for a hybrid vehicle that includes: an engine; a motor that cranks the engine; a battery that supplies electric power to the motor; and an air-fuel ratio sensor that is attached to an exhaust system of the engine and that changes its output value on the basis of an air-fuel ratio. The control method includes: learning a responsiveness of the air-fuel ratio sensor using a slope of the output value of the air-fuel ratio sensor at the time when the motor is cranking the engine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view that shows the schematic configuration of a hybrid vehicle according to an embodiment of the invention;

FIG. 2 is a configuration view that shows the schematic configuration of an engine;

FIG. 3 is a graph that illustrates an example of the output characteristic of an air-fuel ratio sensor and an example of the output characteristic of an oxygen sensor;

FIG. 4 is a graph that illustrates an example of the correlation between a battery temperature Tb and basic values of input/output limits Win and Wout;

FIG. 5 is a graph that illustrates an example of the correlation between a state of charge SOC of a battery and an output limit correction coefficient and an example of the correlation between a state of charge SOC of the battery and an input limit correction coefficient;

FIG. 6 is a flowchart that shows an example of an air-fuel ratio sensor responsiveness learning routine that is executed by an engine ECU according to the embodiment;

FIG. 7 is a graph that illustrates an example of a correlation line that shows the correlation between a start voltage Vaf0 and a maximum slope value ΔVafmax;

FIG. 8 is a graph that illustrates a state of a temporal variation of an engine rotation speed Ne, an intake air amount Qa, an output voltage Vaf of the air-fuel ratio sensor, a slope value ΔVaf at the time when the engine is cranked by a motor MG1 to be started;

FIG. 9 is a flowchart that shows an example of an air-fuel ratio F/B control start permission routine that is executed by the engine ECU;

FIG. 10 is a graph that illustrates an example of a start air-fuel ratio setting map;

FIG. 11 is a graph that shows an example of a state of a temporal variation of an engine rotation speed Ne, an output voltage Vaf of the air-fuel ratio sensor, an air-fuel ratio feedback correction amount ΔQf and whether air-fuel ratio feedback control is executed;

FIGS. 12A and 12B are flowcharts that show an example of an air-fuel ratio sensor responsiveness learning routine according to an alternative embodiment;

FIG. 13 is a flowchart that shows an example of an air-fuel ratio sensor responsiveness learning routine according to an alternative embodiment;

FIG. 14 is a graph that illustrates an example of a correlation line that shows the correlation between an atmospheric pressure Pa and a maximum slope value ΔVafmax;

FIG. 15 is a graph that illustrates an example of a correlation line that shows the correlation between a throttle opening degree TH and a maximum slope value ΔVafmax;

FIG. 16 is a graph that illustrates an example of an integral term limit value setting map;

FIG. 17 is a configuration view that shows the schematic configuration of a hybrid vehicle according to an alternative embodiment;

FIG. 18 is a configuration view that shows the schematic configuration of a hybrid vehicle according to an alternative embodiment;

FIG. 19 is a configuration view that shows the schematic configuration of a hybrid vehicle according to an alternative embodiment; and

FIG. 20 is a configuration view that shows the schematic configuration of a hybrid vehicle according to an alternative embodiment.

### DETAILED DESCRIPTION OF EMBODIMENTS

An embodiment of the invention will be described.

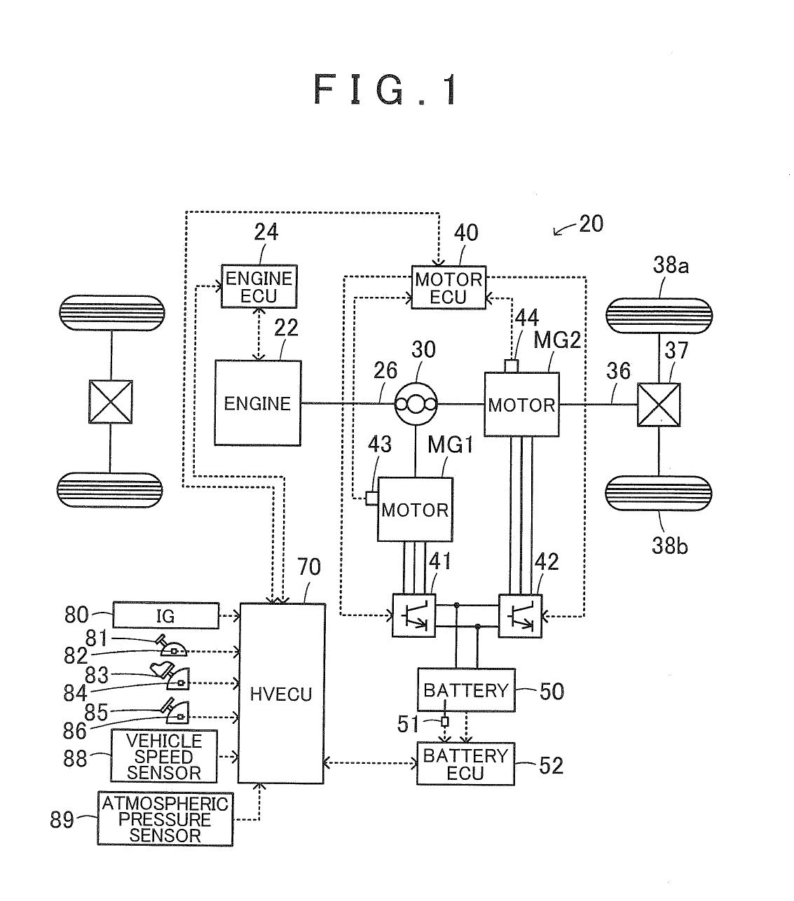

FIG. 1 is a configuration view that shows the schematic configuration of a hybrid vehicle 20 according to the embodiment of the invention. As shown in the drawing, the hybrid vehicle 20 according to the embodiment includes an engine 22, an engine electronic control unit (hereinafter, referred to as engine ECU) 24, a planetary gear 30, a motor MG1, a motor MG2, inverters 41 and 42, a motor electronic control unit (hereinafter, referred to as motor ECU) 40, a battery 50, a battery electronic control unit (hereinafter, referred to as battery ECU) 52 and a hybrid electronic control unit (hereinafter, referred to as HVECU) 70. The engine 22 outputs power using gasoline, light oil, or the like, as fuel. The engine ECU 24 executes drive control over the engine 22. A carrier of the planetary gear 30 is connected to a crankshaft 26 of the engine 22, and a ring gear of the planetary gear 30 is connected to a drive shaft 36 coupled to drive wheels 38a and 38b via a differential gear 37. The motor MG1 is, for example, configured as a synchronous motor generator, and a rotor of the motor MG1 is connected to a sun gear of the planetary gear 30. The motor MG2 is, for example, configured as a synchronous motor generator, and a rotor of the motor MG2 is connected to the drive shaft 36. The inverters 41 and 42 are respectively used to drive the motors MG1 and MG2. The motor ECU 40 executes drive control over the motors MG1 and MG2 by executing switching control over switching elements (not shown) of the inverters 41 and 42. The battery 50 is, for example, configured as a lithium ion secondary battery, and exchanges electric power with the motors MG1 and MG2 via the inverters 41 and 42. The battery ECU 52 manages the battery 50. The HVECU 70 controls the vehicle overall.

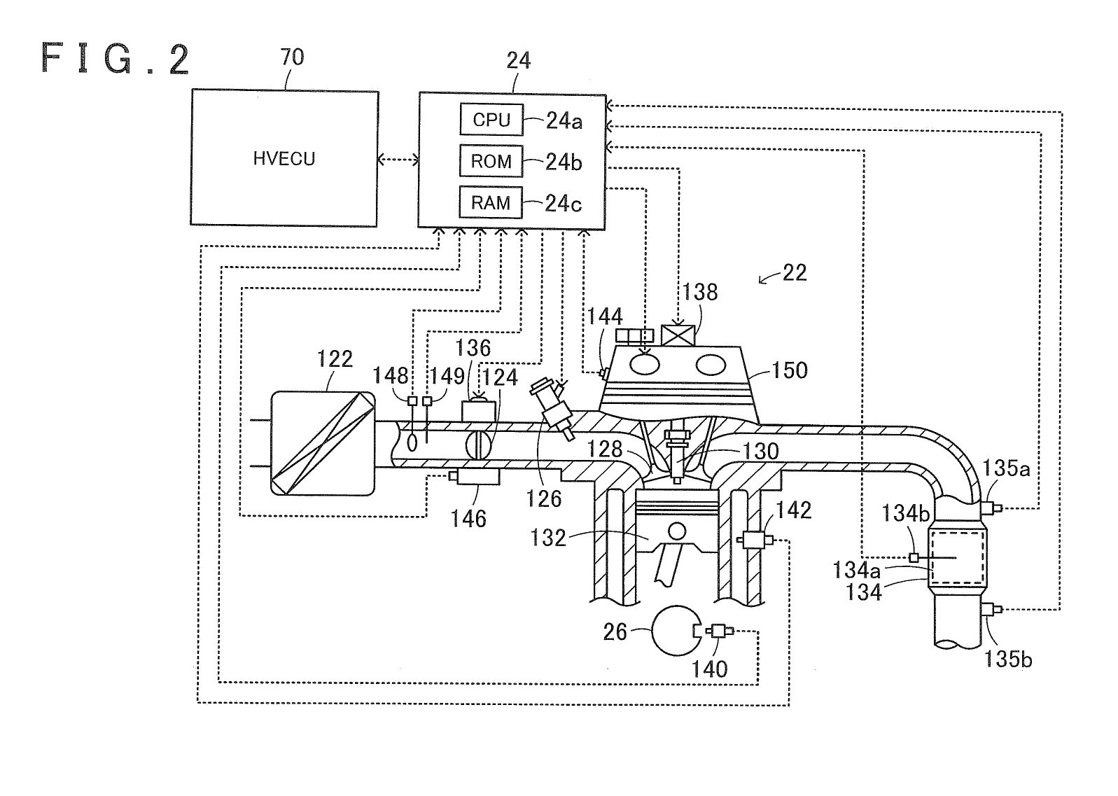

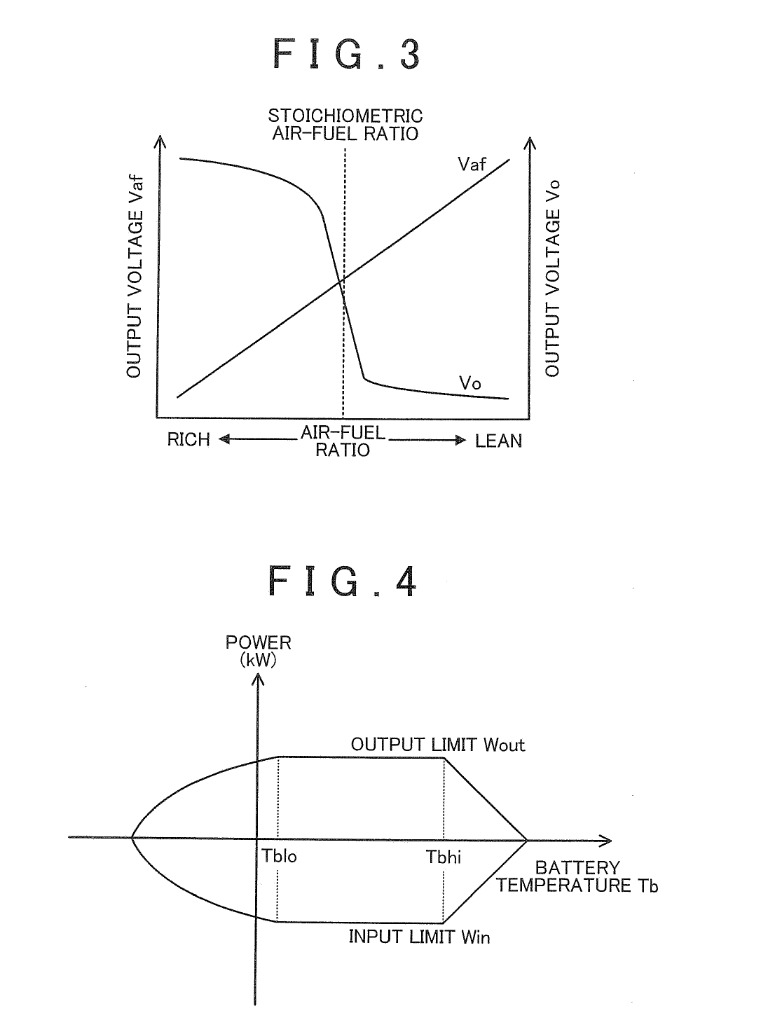

The engine 22 is, for example, configured as an internal combustion engine that is able to output power using hydrocarbon-based fuel, such as gasoline and light oil. As shown in FIG. 2, the engine 22 takes in air, cleaned by an air cleaner 122, via a throttle valve 124, and injects gasoline from a fuel injection valve 126, mixes the intake air with gasoline, introduces the air-fuel mixture into a combustion chamber via an intake valve 128, and causes the air-fuel mixture to explode and burn due to electric spark generated by an ignition plug 130. Then, the engine 22 converts the reciprocal motion of a piston 132 that is pushed down by the generated energy to the rotational motion of the crankshaft 26. Exhaust gas from the engine 22 is emitted to outside air via a purification device 134. The purification device 134 has a purification catalyst (three-way catalyst) 134a that purifies toxic components, such as carbon monoxide (CO), hydrocarbons (HC) and nitrogen oxides (NOx). In the three-way catalyst 134a, oxygen is occluded from exhaust gas when exhaust gas from the engine 22 is lean with respect to a stoichiometric air-fuel ratio, and occluded oxygen is released to exhaust gas when exhaust gas from the engine 22 is rich with respect to the stoichiometric air-fuel ratio. An air-fuel ratio sensor 135a is provided upstream of the purification device 134 in an exhaust pipe of the engine 22. An output value (output voltage Vaf) of the air-fuel ratio sensor 135a substantially linearly varies on the basis of an air-fuel ratio. An oxygen sensor 135b is provided downstream of the purification device 134 in the exhaust pipe. An output value (output voltage Vo) of the oxygen sensor 135b steeply varies on the basis of whether the air-fuel ratio is rich or lean with respect to the stoichiometric air-fuel ratio. FIG. 3 shows an example of the output characteristic of the air-fuel ratio sensor 135a and an example of the output characteristic of the oxygen sensor 135b. In the example shown in FIG. 3, the output voltage Vaf of the air-fuel ratio sensor 135a substantially linearly increases as the air-fuel ratio increases, and the output value Vo of the oxygen sensor 135b is relatively large when the air-fuel ratio is rich with respect to the stoichiometric air-fuel ratio and is relatively small when the air-fuel, ratio is lean with respect to the stoichiometric air-fuel ratio.

The engine ECU 24 is configured as a microprocessor that is mainly formed of a CPU 24a. In addition to the CPU 24a, the engine ECU 24 includes a ROM 24b, a RAM 24c, input/output ports (not shown) and a communication port (not shown). The ROM 24b stores a processing program. The RAM 24c temporarily stores data. Signals from various sensors that detect states of the engine 22 are input to the engine ECU 24 via the input port. The signals are, for example, a crank position, a coolant temperature Tw, an in-cylinder pressure Pin, a cam position, a throttle opening degree TH, an intake air amount Qa, an intake air temperature Tin, a catalyst temperature Tc, the output voltage Vaf, the output voltage Vo, and the like. The crank position is transmitted from a crank position sensor 140 that detects the rotational position of the crankshaft 26. The coolant temperature Tw is transmitted from a coolant temperature sensor 142 that detects the temperature of coolant of the engine 22. The in-cylinder pressure Pin is transmitted from a pressure sensor (not shown) attached inside the combustion chamber. The cam position is transmitted from a cam position sensor 144 that detects the rotational position of a camshaft that opens or closes the intake valve 128 that introduces air into the combustion chamber or an exhaust valve that emits exhaust gas from the combustion chamber. The throttle opening degree TH is transmitted from a throttle valve position sensor 146 that detects the position of the throttle valve 124. The intake air amount Qa is transmitted from an air flow meter 148 attached to an intake pipe. The intake air temperature Tin is transmitted from a temperature sensor 149 similarly attached to the intake pipe. The catalyst temperature Tc is transmitted from a temperature sensor 134b that detects the temperature of the purification catalyst 134a. The output voltage Vaf is transmitted from the air-fuel ratio sensor 135a attached to an exhaust pipe. The output voltage Vo is transmitted from the oxygen sensor 135b similarly attached to the exhaust pipe. In addition, various control signals for driving the engine 22 are output from the engine ECU 24 via the output port. The control signals are, for example, a driving signal to the fuel injection valve 126, a driving signal to a throttle motor 136 that adjusts the position of the throttle valve 124, a control signal to an ignition coil 138 integrated with an igniter, a control signal to a variable valve timing mechanism 150 that is able to change the open/close timing of the intake valve 128, and the like. The engine ECU 24 communicates with the HVECU 70. The engine ECU 24 executes operation control over the engine 22 on the basis of a control signal from the HVECU 70, and, where necessary, outputs data relating to the operating states of the engine 22. Note that the engine ECU 24 computes the rotation speed of the crankshaft 26, that is, the rotation speed Ne of the engine 22, on the basis of the crank position from the crank position sensor 140.

Although not shown in the drawing, the motor ECU 40 is configured as a microprocessor mainly formed of a CPU, and, in addition to the CPU, includes a ROM, a RAM, input/output ports and a communication port. The ROM stores a processing program. The RAM temporarily stores data. Signals that are required to execute drive control over the motors MG1 and MG2 are input to the motor ECU 40 via the input port. The signals are, for example, rotational positions θm1 and θm2, phase currents, and the like. The rotational positions θm1 and θm2 are respectively transmitted from rotational position detection sensors 43 and 44 that respectively detect the rotational positions of the rotors of the motors MG1 and MG2. The phase currents are applied to the motors MG1 and MG2 and detected by a current sensor (not shown). For example, switching control signals that are transmitted to the switching elements (not shown) of the inverters 41 and 42 are output from the motor ECU 40 via the output port. In addition, the motor ECU 40 communicates with the HVECU 70. The motor ECU 40 executes drive control over the motors MG1 and MG2 through control signals from the HVECU 70, and, where necessary, outputs data relating to the operating states of the motors MG1 and MG2 to the HVECU 70. Note that the motor ECU 40 also computes rotation angular velocities ωm1 and ωm2 and rotation speeds Nm1 and Nm2 of the motors MG1 and MG2 on the basis of the rotational positions θm1 and θm2 of the rotors of the motors MG1 and MG2 from the rotational position detection sensors 43 and 44.

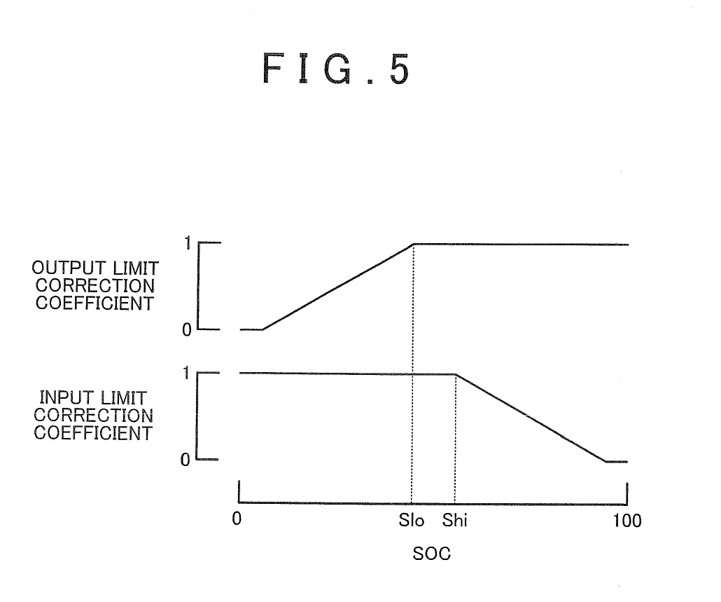

Although not shown in the drawing, the battery ECU 52 is configured as a microprocessor mainly formed of a CPU, and, in addition to the CPU, includes a ROM, a RAM, input/output ports and a communication port. The ROM stores a processing program. The RAM temporarily stores data. Signals that are required to manage the battery 50 are input to the battery ECU 52. The signals are, for example, a terminal voltage Vb, a charge/discharge current Ib, a battery temperature Tb, and the like. The terminal voltage Vb is transmitted from a voltage sensor (not shown) provided between the terminals of the battery 50. The charge/discharge current Ib is transmitted from the current sensor (not shown) arranged in a power line connected to the output terminal of the battery 50. The battery temperature Tb is transmitted from the temperature sensor 51 attached to the battery 50. Where necessary, the battery ECU 52 transmits data relating to the states of the battery 50 to the HVECU 70 via communication. In order to manage the battery 50, the battery ECU 52 computes the state of charge SOC on the basis of an accumulated value of the charge/discharge current Ib detected by the current sensor and computes input/output limits Win and Wout on the basis of the computed state of charge SOC and the battery temperature Tb. The state of charge SOC is the percentage of the level of electric power that is dischargeable from the battery 50 with respect to the full level at that time. The input/output limits Win and Wout are maximum permissible electric powers at which the battery 50 may be charged and discharged. It is possible to set the input/output limits Win and Wout of the battery 50 as follows. Basic values of the input/output limits Win and Wout are set on the basis of the battery temperature Tb, an output limit correction coefficient and an input limit correction coefficient are set on the basis of the state of charge SOC of the battery 50, and then the set basic values of the input/output limits Win and Wout are multiplied by the respective correction coefficients. FIG. 4 shows an example of the correlation between a battery temperature Tb and basic values of the input/output limits Win and Wout. FIG. 5 shows an example of the correlation between a state of charge SOC of the battery 50 and an output limit correction coefficient and an example of the correlation between a state of charge SOC of the battery 50 and an input limit correction coefficient. The thus set input limit Win is limited by a larger amount (the absolute value of the input limit Win is set to a smaller value) as the battery temperature Tb decreases in a range in which the battery temperature Tb is lower than a predetermined temperature Tblo (for example, 0° C., 5° C., 10° C., or the like), and is limited by a larger amount as the battery temperature Tb increases in a range in which the battery temperature Tb is higher than a predetermined temperature Tbhi (for example, 45° C., 50° C., 55° C., or the like). In addition, the input limit Win is limited by a larger amount as the state of charge SOC increases in a range in which the state of charge SOC is higher than a predetermined value Shi (for example, 55%, 60%, 65%, or the like). The output limit Wout is limited by a larger amount as the battery temperature Tb decreases in a range in which the battery temperature Tb is lower than the predetermined temperature Tblo, and is limited by a larger amount as the battery temperature Tb increases in a range in which the battery temperature Tb is higher than the predetermined temperature Tbhi. In addition, the output limit Wout is limited by a larger amount as the state of charge SOC decreases in a range in which the state of charge SOC is lower than a predetermined value Slo (for example, 35%, 40%, 45%, or the like).

Although not shown in the drawing, the HVECU 70 is configured as a microprocessor mainly formed of a CPU, and, in addition to the CPU, includes a ROM, a RAM, input/output ports and a communication port. The ROM stores a processing program. The RAM temporarily stores data. An ignition signal, a shift position SP, an accelerator operation amount Acc, a brake pedal position BP, a vehicle speed V, an atmospheric pressure Pa, and the like, are input to the HVECU 70 via the input port. The ignition signal is transmitted from an ignition switch 80. The shift position SP is transmitted from a shift position sensor 82 that detects the operating position of a shift lever 81. The accelerator operation amount Acc is transmitted from an accelerator pedal position sensor 84 that detects the depression amount of an accelerator pedal 83. The brake pedal position BP is transmitted from a brake pedal position sensor 86 that detects the depression amount of a brake pedal 85. The vehicle speed V is transmitted from a vehicle speed sensor 88. The atmospheric pressure Pa is transmitted from an atmospheric pressure sensor 89. As described above, the HVECU 70 is connected to the engine ECU 24, the motor ECU 40 and the battery ECU 52 via the communication port, and exchanges various control signals and data with the engine ECU 24, the motor ECU 40 and the battery ECU 52.

The thus configured hybrid vehicle 20 according to the embodiment calculates a required torque Tr*, which should be output to the drive shaft 36, on the basis of the accelerator operation amount Acc, corresponding to the driver's depression amount of the accelerator pedal, and the vehicle speed V, and executes operation control over the engine 22, the motor MG1 and the motor MG2 such that a required power corresponding to the required torque Tr* is output to the drive shaft 36. The operation control over the engine 22, the motor MG1 and the motor MG2 includes a torque conversion operation mode, a charge/discharge operation mode, a motor operation mode, and the like. In the torque conversion operation mode, the engine 22 is subjected to operation control such that a power equivalent to the required power is output from the engine 22, and the motor MG1 and the motor MG2 are subjected to operation control such that all the power that is output from the engine 22 is converted into torque by the planetary gear 30, the motor MG1 and the motor MG2 and is output to the drive shaft 36. In the charge/discharge operation mode, the engine 22 is subjected to operation control such that a power equivalent to the sum of the required power and an electric power that is required to charge or discharge the battery 50 is output from the engine 22, and the motor MG1 and the motor MG2 are subjected to drive control such that all or part of the power that is output from the engine 22 while the battery 50 is charged or discharged is converted to torque by the planetary gear 30, the motor MG1 and the motor MG2 and the required power is output to the drive shaft 36. In the motor operation mode, operation control is executed such that the operation of the engine 22 is stopped and a power equivalent to the required power from the motor MG2 is output to the drive shaft 36. The torque conversion operation mode and the charge/discharge operation mode each are a mode in which the engine 22, the motor MG1 and the motor MG2 are controlled such that the required power is output to the drive shaft 36 while the engine 22 is operated, and there is no substantial difference in control therebetween, so both are referred to as engine operation mode hereinafter.

In the engine operation mode, the HVECU 70 sets the required torque Tr*, which should be output to the drive shaft 36, on the basis of the accelerator operation amount Acc from the accelerator pedal position sensor 84 and the vehicle speed V from the vehicle speed sensor 88, calculates a drive power Pdrv*, which is required for travelling, by multiplying the set required torque Tr* by the rotation speed Nr of the drive shaft 36 (for example, a rotation speed that is obtained by multiplying the rotation speed Nm2 of the motor MG2 or the vehicle speed V by a conversion coefficient), and sets a required power Pe*, which is a power that should be output from the engine 22, by subtracting a charge/discharge required power Pb* (which is positive when the battery 50 is discharged) of the battery 50 from the calculated drive power Pdrv*. Then, a target rotation speed Ne* and target torque Te* of the engine 22 are set using an operation line (for example, a fuel economy optimal operation line) that serves as the correlation between the rotation speed Ne and torque Te of the engine 22, at which it is possible to efficiently output the required power Pe* from the engine 22. Within the range of the input/output limits Win and Wout of the battery 50, a torque command Tm1* that is a torque that should be output from the motor MG1 through rotation speed feedback control for bringing the rotation speed Ne of the engine 22 into coincidence with the target rotation speed Ne* is set, and a torque command Tm2* of the motor MG2 is set by subtracting a torque, which acts on the drive shaft 36 via the planetary gear 30 when the motor MG1 is driven in accordance with the torque command Tm1*, from the required torque Tr*. The set target rotation speed Ne* and target torque Te* are transmitted to the engine ECU 24, and the torque commands Tm1* and Tm2* are transmitted to the motor ECU 40. The engine ECU 24 that has received the target rotation speed Ne* and the target torque Te* executes intake air amount control, fuel injection control, ignition control, and the like, over the engine 22 such that the engine 22 is operated at the target rotation speed Ne* and the target torque Te*. The motor ECU 40 that has received the torque commands Tm1* and Tm2* executes switching control over the switching elements of the inverters 41 and 42 such that the motors MG1 and MG2 are driven in accordance with the torque commands Tm1* and Tm2*. Through the above controls, the hybrid vehicle 20 is able to travel by outputting the required torque Tr* to the drive shaft 36 within the range of the input/output limits Win and Wout of the battery 50 while efficiently operating the engine 22. In the engine operation mode, for example, when the required power Pe* of the engine 22 has reached a value smaller than or equal to a stop threshold Pstop that is determined as an upper limit of the range of the required power Pe*, above which the operation of the engine 22 should be stopped, it is determined that a condition for stopping the engine 22 is satisfied, and the operation of the engine 22 is stopped, after which the mode shifts into the motor operation mode.

Here, fuel injection control over the engine 22 will be described. In fuel injection control, first, a basic fuel injection amount Qftmp for bringing the air-fuel ratio into coincidence with a target air-fuel ratio AF* (for example, the stoichiometric air-fuel ratio) is set on the basis of the intake air amount Qa from the air flow meter 148, an air-fuel ratio feedback correction amount ΔQf is set through the following mathematical expression (1) such that an air-fuel ratio (hereinafter, referred to as detected air-fuel ratio ΔFdet) corresponding to the output voltage Vaf of the air-fuel ratio sensor 135a coincides with the target air-fuel ratio AF*, a target fuel injection amount Qf* is set by adding the set air-fuel ratio feedback correction amount ΔQf to the basic fuel injection amount Qftmp, and the fuel injection valve 126 is controlled using the set target fuel injection amount Qf*. Here, the mathematical expression (1) is a relational expression that is used in feedback control (air-fuel ratio feedback control) for bringing the detected air-fuel ratio AFdet into coincidence with the target air-fuel ratio AF*. In the mathematical expression (1), “k1” is a proportional-term gain, and “k2” is an integral-term gain. Note that, when air-fuel ratio feedback control is not executed, for example, immediately after completion of a start of the engine 22, the basic fuel injection amount Qftmp is set to the target fuel injection amount Qf*, and the fuel injection valve 126 is controlled using the set target fuel injection amount Qf*.

ΔQF=k1·(AF*−AFdet)+k2·∫(AF*−AFdet)dt (1)

In the motor operation mode, the HVECU 70 sets the required torque Tr*, which should be output to the drive shaft 36, on the basis of the accelerator operation amount Acc and the vehicle speed V, sets a value 0 for the torque command Tm1* of the motor MG1 and sets the torque command Tm2* of the motor MG2 within the input/output limits Win and Wout of the battery 50 such that the required torque Tr* is output to the drive shaft 36, and then transmits the torque commands Tm1* and Tm2* to the motor ECU 40. The motor ECU 40 that has received the torque commands Tm1* and Tm2* executes switching control over the switching elements of the inverters 41 and 42 such that the motors MG1 and MG2 are respectively driven in accordance with the torque commands Tm1* and Tm2*. Through such control, the hybrid vehicle 20 is able to travel by outputting the required torque Tr* to the drive shaft 36 within the range of the input/output limits Win and Wout of the battery 50 in a state where the operation of the engine 22 is stopped. In the motor operation mode, for example, when the required power Pe* of the engine 22, which is obtained by subtracting the charge/discharge required power Pb* of the battery 50 from the drive power Pdrv* that is obtained by multiplying the required torque Tr* by the rotation speed Nr of the drive shaft 36, has reached a value that is larger than or equal to a start threshold Pstart that is determined as a lower limit of the range of the required power Pe*, below which the engine 22 should be started, it is determined that a condition for starting the engine 22 is satisfied, after which the engine 22 is started and the mode shifts into the engine operation mode.

The engine 22 is started as follows. Within the range of the input/output limits Win and Wout of the battery 50, a cranking torque Tc for cranking the engine 22 is output from the motor MG1, and a torque for cancelling a torque that acts on the drive shaft 30 as a result of the output of the torque is output from the motor MG2. By so doing, the engine 22 is cranked. When the rotation speed Ne of the engine 22 has reached a predetermined rotation speed Nest (for example, 1000 rpm), fuel injection control, ignition control, and the like, are started. Note that, during a start of the engine 22 as well, drive control over the motor MG2 is executed, such that the required torque Tr* is output to the drive shaft 36. That is, the torque that should be output from the motor MG2 is the sum of the required torque Tr* and the torque for cancelling the torque that acts on the drive shaft 36 at the time when the engine 22 is cranked by the motor MG1. In the embodiment, when the engine 22 is cranked by the motor MG1, the engine 22 is controlled such that the throttle opening degree TH becomes an idling target opening degree THid* that is a throttle opening degree TH when idle operation is performed.

In the hybrid vehicle 20 according to the embodiment, when the idle operation of the engine 22 is performed, the idling target opening degree THid* is set by correcting a basic opening degree THtmp such that a difference between the rotation speed Ne of the engine 22 and the idle rotation speed Nid1 is cancelled, the engine 22 is controlled using the set idling target opening degree THid*, and the idling target opening degree THid* is learned. The basic opening degree THtmp is predetermined such that the rotation speed Ne of the engine 22 becomes the idle rotation speed Nid1.

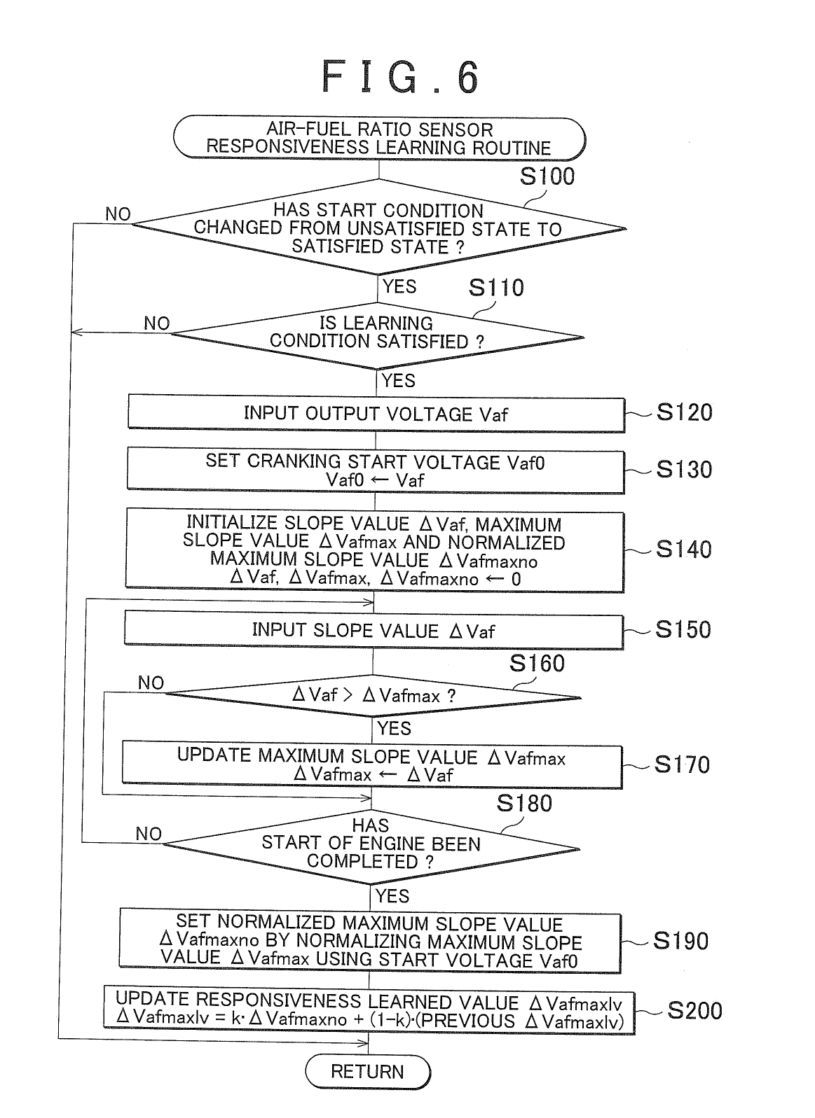

Next, the operation of the thus configured hybrid vehicle 20 according to the embodiment, particularly, the operation at the time of learning the responsiveness of the air-fuel ratio sensor 135a, will be described. FIG. 6 is a flowchart that shows an example of an air-fuel ratio sensor responsiveness learning routine that is executed by the engine ECU 24 according to the embodiment. The routine is repeatedly executed.

When the air-fuel ratio sensor responsiveness learning routine is executed, the CPU 24a of the engine ECU 24 initially determines whether it is the timing at which file condition for starting the engine 22 has changed from an unsatisfied state to a satisfied state (step S100), and, when it is determined that it is not the timing at which the condition for starting the engine 22 has changed from an unsatisfied state to a satisfied state, ends the routine. Here, the timing at which the condition for starting the engine 22 has changed from an unsatisfied state to a satisfied state may be presumably, for example, the timing when the required power Pe* has reached a value that is larger than or equal to the start threshold Pstart while the hybrid vehicle 20 is travelling in the motor operation mode. The process of step S100 is a process of determining whether it is the timing at which the motor MG1 starts cranking the engine 22.

When it is determined in step S100 that it is the timing at which the condition for starting the engine 22 has changed from an unsatisfied state to a satisfied state, it is determined whether a condition for learning the responsiveness of the air-fuel ratio sensor 135a is satisfied (step S110). When it is determined that the learning condition is not satisfied, the routine is ended. Here, the learning condition may be, for example, a time condition that a predetermined period of time (for example, one second, two seconds, or the like) has elapsed from a stop of the operation of the engine 22, a voltage condition that the output voltage Vaf of the air-fuel ratio sensor 135a is lower than a predetermined voltage Vafref, or the like. Here, the predetermined voltage Vafref is a voltage corresponding to a predetermined air-fuel ratio (for example, 17, 18, or the like) that is larger than the stoichiometric air-fuel ratio (14.6). In the embodiment, it is determined that the learning condition is not satisfied when at least one of the time condition and the voltage condition is not satisfied, and it is determined that the learning condition is satisfied when all the conditions are satisfied.

When it is determined in step S110 that the learning condition is satisfied, the output voltage Vaf of the air-fuel ratio sensor 135a is input and is set for a start voltage Vaf0 that is the output voltage Vaf at the time of starting cranking the engine 22 (steps S120 and S130), and an initial value 0 is set for each of a slope value ΔVaf, a maximum slope value ΔVafmax and a normalized maximum slope value ΔVafmaxlv (step S140). The slope value ΔVaf is a variation per unit time (for example, 50 msec, 60 msec, 70 msec, or the like) of the output voltage Vaf. The maximum slope value ΔVafmax is a maximum value of the slope value ΔVaf. The normalized maximum slope value ΔVafmaxlv is a value that is obtained by normalizing the maximum slope value ΔVafmax.

Subsequently, the slope value ΔVaf is input (step S150), and the input slope value ΔVaf is compared with the maximum slope value ΔVafmax (step S160). When the slope value ΔVaf is larger than the maximum slope value ΔVafmax, the slope value ΔVaf is set for the maximum slope value ΔVafmax, that is, the maximum slope value ΔVafmax is updated (step S170); whereas, when the slope value ΔVaf is smaller than or equal to the maximum slope value ΔVafmax, the process of step S170 is not executed. Here, a value obtained by subtracting the output voltage Vaf a unit time before from the current output voltage Vaf of the air-fuel ratio sensor 135a is input as the slope value ΔVaf through a slope value computing routine (not shown) that is executed by the engine ECU 24.

It is determined whether a start of the engine 22 has been completed (whether cranking of the engine 22 has been finished) (step S180), and, when it is determined that a start of the engine 22 has not been completed (cranking of the engine 22 has not been finished), the process returns to step S150. Note that it is possible to determine whether a start of the engine 22 has been completed on the basis of, for example, whether the engine 22 has made a complete explosion.

By repeatedly executing the processes of steps S150 to S180 in this way, when it is determined that a start of the engine 22 has been completed (cranking of the engine 22 has been finished), the maximum slope value ΔVafmax is normalized using the start voltage Vaf0 and set for the normalized maximum slope value ΔVafmaxno (step S190), and a learned value ΔVafmaxlv of the responsiveness of the air-fuel ratio sensor 135a is set using the set normalized maximum slope value ΔVafmaxno (step S200), after which the routine is ended.

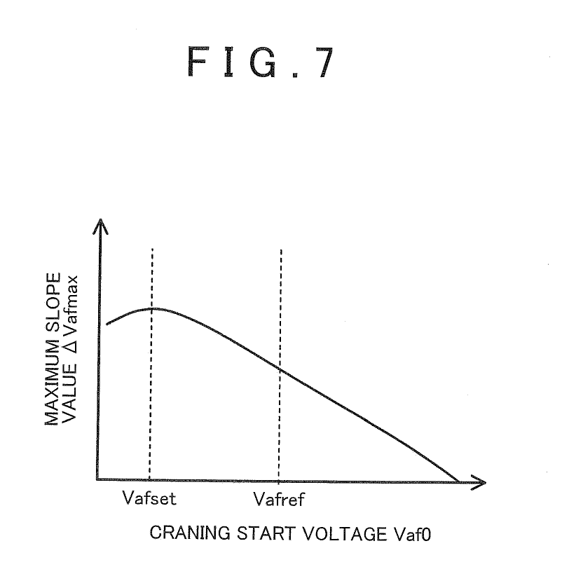

In the embodiment, setting of the normalised maximum slope value ΔVafmaxno in step S190 is performed by normalizing (converting) the maximum slope value ΔVafmax using the start voltage Vaf0 into the maximum slope value ΔVafmax at a predetermined air-fuel ratio-corresponding voltage Vafset that is the output voltage Vaf of the air-fuel ratio sensor 135a, corresponding to the predetermined air-fuel ratio (for example, the stoichiometric air-fuel ratio) AFset. FIG. 7 is a graph that illustrates an example of a correlation line that shows the correlation between a start voltage Vaf0 and a maximum slope value ΔVafmax. Hereinafter, a maximum slope value corresponding to each start voltage Vaf0 in the correlation line is denoted by “ΔVafmaxf[Vaf0]”. The correlation line may be, for example, obtained as follows. A plurality of correlations between a start voltage Vaf0 and a maximum slope value ΔVafmax are obtained through an experiment, analysis, or the like, in advance, and then plotted as points, and then approximation of function is performed using the plotted plurality of points through least-squares method, or the like. As is apparent from FIG. 7, the air-fuel ratio sensor 135a has such a characteristic that the maximum slope value ΔVafmax varies on the basis of the start voltage Vaf0. Specifically, the air-fuel ratio sensor 135a has such a characteristic that the start voltage Vaf0 takes a local maximum near the predetermined air-fuel ratio-corresponding voltage Vafset and the maximum slope value ΔVafmax reduces as the start voltage Vaf0 distances from near the predetermined air-fuel ratio-corresponding voltage Vafset. In consideration of this characteristic, in the embodiment, the normalized maximum slope value ΔVafmaxno is calculated through the following mathematical expression (2) using the maximum slope value ΔVafmax, the start voltage Vaf0 in the correlation line, the maximum slope value ΔVafmaxf[Vaf0] corresponding to the predetermined air-fuel ratio-corresponding voltage Vafset and ΔVafmaxf[Vafset]. Through the above process, it is possible to make it easy to utilize data (normalised maximum slope value ΔVafmaxno). In FIG. 7, the above-described predetermined voltage Vafref is also shown for reference. In a range in which the start voltage Vaf0 is higher than or equal to the predetermined voltage Vafref, a value of “ΔVafmaxf[Vafset]/ΔVafmax[Vaf0]” in the mathematical expression (2) remarkably increases, so it is presumable that the accuracy (reliability) of normalization is relatively low. Therefore, in the embodiment, in the above-described process of step S110, the voltage condition that the output voltage Vaf of the air-fuel ratio sensor 135a is lower than the predetermined voltage Vafref is taken into consideration.

ΔVafmaxno×ΔVafmax·ΔVafmax[Vafset]/ΔVafmaxf[Vaf0] (2)

Setting of the learned value ΔVafmaxlv of the responsiveness of the air-fuel ratio sensor 135a in step S200 is performed by calculating the following mathematical expression (3) using the normalised maximum slope value ΔVafmaxno and a previous learned value (previous ΔVafmaxlv) of the responsiveness of the air-fuel ratio sensor 135a. Here, in the mathematical expression (3), “kv” is a reflecting coefficient kv for reflecting the normalized maximum slope value ΔVafmaxno into a new learned value ΔVafmaxlv, and a value that is larger than 0 and smaller than 1 may be, for example, 0.10, 0.15, 0.20, or the like. By calculating the learned value ΔVafmaxlv of the responsiveness of the air-fuel ratio sensor 135a using the reflecting coefficient kv in this way, it is possible to suppress a steep variation, in the learned value ΔVafmaxlv.

ΔVafmaxlv=kv·ΔVafmaxno+(1−kv)·(previous ΔVafmaxlv) (3)

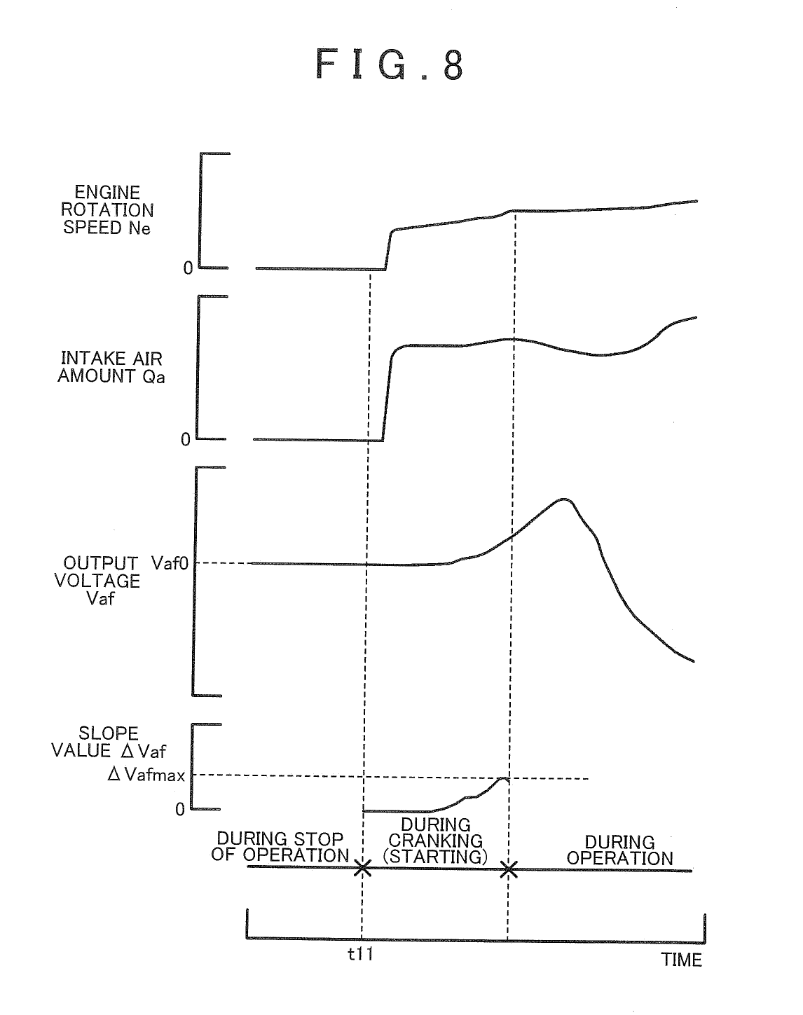

Here, the reason why the responsiveness of the air-fuel ratio sensor 135a is learned at the time when the engine 22 is being cranked will be described, FIG. 1 is a graph that illustrates a state of a temporal variation in the rotation speed Ne of the engine 22, the intake air amount Qa, the output voltage Vaf of the air-fuel ratio sensor 135a and the slope value ΔVaf at the time when the engine 22 is cranked by the motor MG1 to be started. As shown in FIG. 8, when the motor MG1 starts cranking the engine 22 (time t11), the output voltage W of the air-fool ratio sensor 135a increases (becomes a lean-side value) due to an increase in tire rotation speed Me of the engine 22 or the intake air amount Qa, and the slope value ΔVaf increases. At the time when the engine 22 is being cranked (particularly, before the rotation speed. Ne reaches the predetermined rotation speed Nest), fuel injection is not carried out in the engine 22, and the intake air amount Qa is relatively small. Thus, in comparison with during operation in which fuel infection is being carried out in the engine 22 or during fuel cut in which fuel injection is not being carried out in the engine 22 but the intake air amount Qa is relatively large (fuel cut. is being performed while the engine 22 is rotating at a somewhat high-rotation speed Ne), a further detailed difference of the responsiveness of the air-fuel ratio sensor 135a tends to appear in the slope value ΔVaf As a result, by calculating the learned value ΔVafmaxlv of the responsiveness of the air-fuel ratio sensor 135a at the time when the engine 22 is being cranked, it is possible to further appropriately learn the responsiveness of the air-fuel ratio sensor 135a. In so-called one trip from a system, start to a system stop, the hybrid vehicle 20 travels while intermittently operating the engine 22 (while starting or stopping the engine 22). Therefore, by learning the responsiveness, of the air-fuel ratio sensor 135a at the time when the engine 22 is being cranked, it is presumably possible to have a larger number of opportunities to learn the responsiveness in comparison with the case where the responsiveness of the air-fuel ratio sensor 135a is learned after a lapse of a certain period of time from a start of the engine 22.

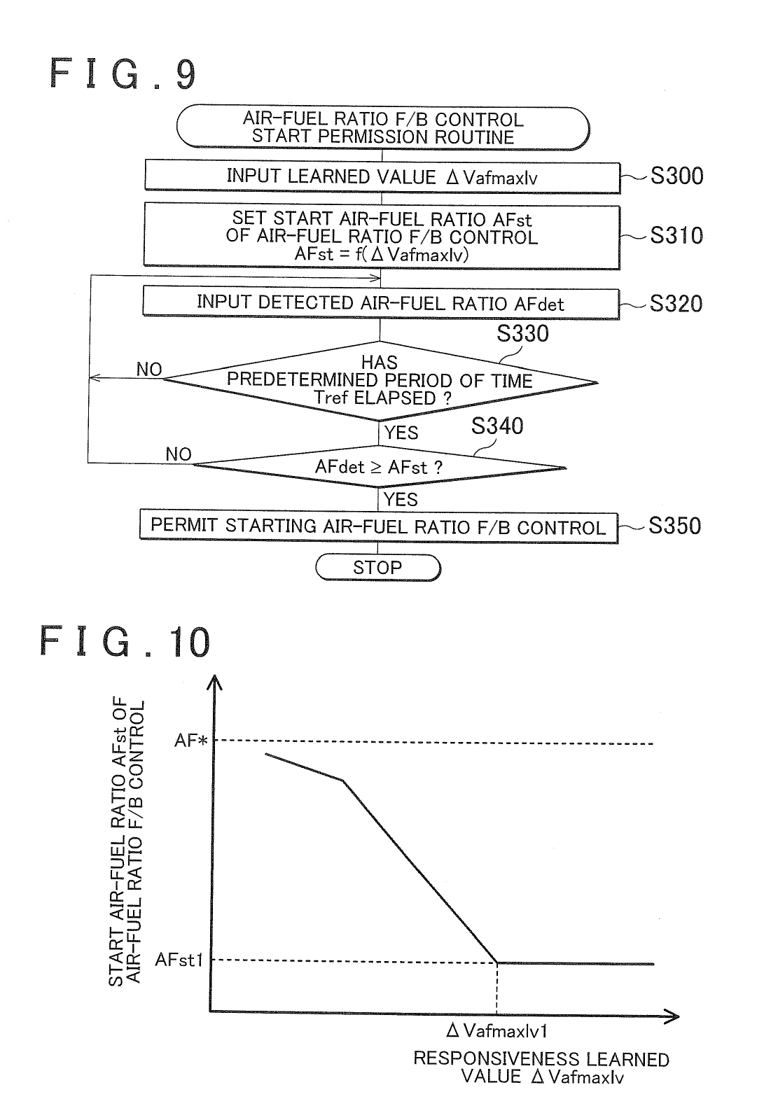

The operation at the time of learning the responsiveness of the air-fuel. ratio sensor 135a (updating the learned value ΔVafmaxlv) is described above. Next, the operation at the time of permitting a start of air-fuel ratio feedback control after a start of the engine 22 using the learned value ΔVafmaxlv of the responsiveness of the air-fuel ratio sensor 135a will be described. FIG. 9 is a flowchart that shows an example of an air-fuel ratio F/B control start permission routine that is executed by the engine ECU 24, The routine is started at the time when a start of the engine 22 has been completed.

When the air-fuel ratio F/B control start permission routine is executed, the CPU 24a of the engine ECU 24 initially loads the learned value ΔVafmaxlv (step S300), and sets a start air-fuel ratio AFst, which is an air-fuel ratio at which a start of air-fuel ratio feedback control is permitted, on the basis of the loaded learned value ΔVafmaxlv (step S310). Here, in the embodiment, the start air-fuel ratio AFst is set as follows. The correlation between a learned value ΔVafmaxlv and a start air-fuel ratio AFst is determined in advance and is stored in the ROM 24b as a start air-fuel ratio setting map, and, when the learned value ΔVafmaxlv is given, a corresponding start air-fuel ratio AFst is derived from the map. An example of the start air-fuel ratio setting map is shown in FIG. 10. As shown in the graph, within a (rich-side) range in which an air-fuel ratio is smaller than the target air-fuel ratio AF* (for example, the stoichiometric air-fuel ratio), the start air-fuel ratio AFst is set to a fixed value AFst1 in a range in which the learned value ΔVafmaxlv is larger than or equal to a predetermined value ΔVafmaxlvl, and the start air-fuel ratio AFst is set so as to increase as the learned, value ΔVafmaxlv reduces in a range in which the learned value ΔVafmaxlv is smaller than the predetermined value ΔVafmaxlvl. The reason why the start air-fuel ratio AFst is set in this way will be described later,

When the start air-fuel ratio AFst is set in this way, the detected air-fuel ratio AFdet corresponding to the output voltage Vaf of the air-fuel ratio sensor 135a is input (step S320), it is determined whether a predetermined period of time Tref (for example, 400 msec, 500 msec, 600 msec, or the like) has elapsed from completion of a start of the engine 22 (step S330), and it is determined whether the detected air-fuel ratio AFdet is larger than or equal to the start air-fuel ratio AFst (step S340), When the predetermined period of time Tref has not elapsed from completion of a start of the engine 22 or when the detected air-fuel ratio AF is smaller than the start air-fuel ratio AFst, the process returns to step S320. When the predetermined period of time Tref has elapsed from completion of a start of the engine 22 and the detected air-fuel ratio AFdet is larger than or equal to the start air-fuel ratio AFst, a start of air-fuel ratio feedback control is permitted (step S350). Then, the routine is ended,

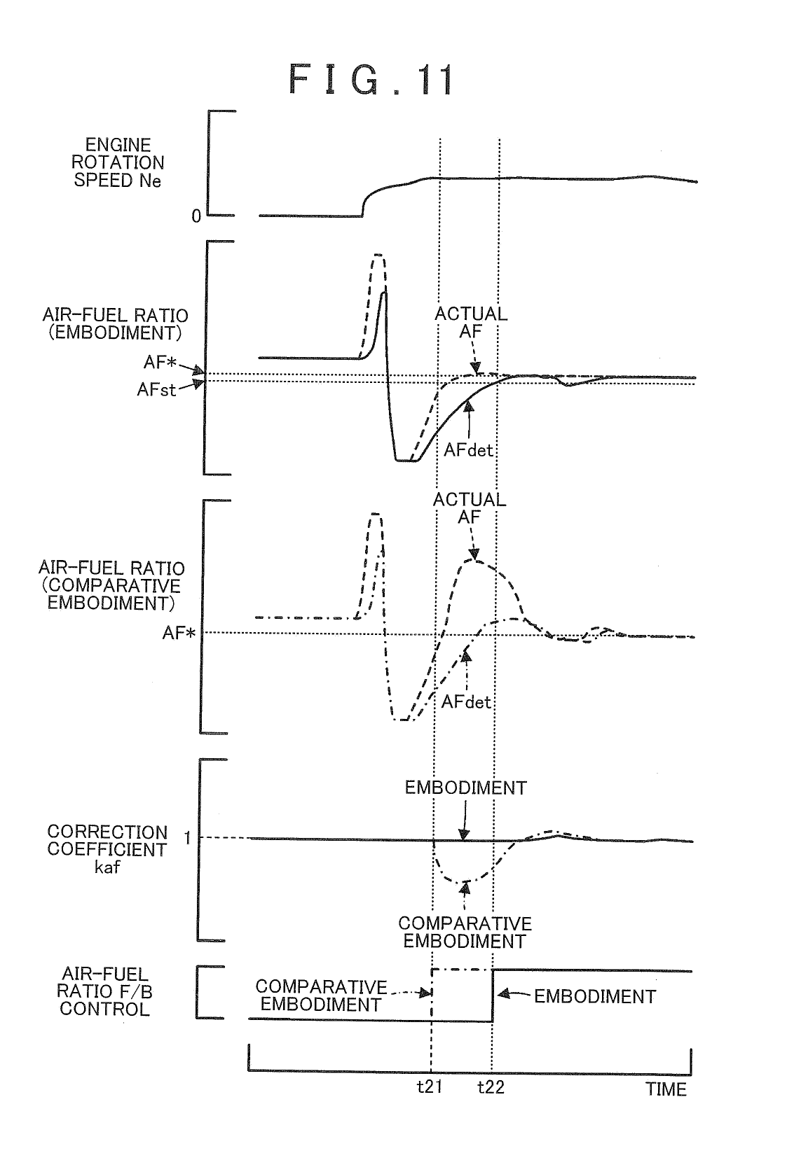

FIG. 11 is a graph that illustrates an example of a state of a temporal variation in the rotation speed Ne of the engine 22, the output voltage Vaf of the air-fuel ratio sensor 135a, the air-fuel ratio feedback correction amount ΔQf and whether, air-fuel ratio feedback control is executed. In the graph, the solid line indicates a state of the embodiment, and the alternate long and short dash line indicates a state of a comparative embodiment in which air-fuel ratio feedback control is started at time t21 at which the predetermined period of time Tref has elapsed from completion of a start of the engine 22. In the example of FIG. 11, a state where the responsiveness of the air-fuel ratio sensor 135a is relatively low is shown. An actual air-fuel ratio (actual AF) usually deviates toward a lean side by a relatively large amount at the time when the engine 22 is being started (cranked), and, after completion of the start of the engine 22, once deviates toward a rich side by a large amount, and then approaches the target air-fuel ratio AF*. In the comparative embodiment, air-fuel ratio feedback control is started at time t21, so air-fuel ratio feedback control is started in a state where the detected air-fuel ratio AFdet is somewhat distanced from the target air-fuel ratio AF*, and an actual air-fuel ratio (actual AF) may deviate toward a lean side by a large amount with respect to the target air-fuel, ratio AF*. In contrast to this, in the embodiment, when the detected air-fuel ratio AFdet is smaller than the start air-fuel ratio AFst at time t21, air-fuel ratio feedback control is started at time t22 at which the detected air-fuel ratio AFdet has reached a value that is larger than or equal to the start air-feel ratio AFst. By so doing, it is possible to suppress a deviation of an actual air-fuel ratio (actual AF) toward a lean side by a large amount. The predetermined period of time Tref is set to a period of time by which, when the responsiveness of the air-fuel ratio sensor 135a is high (for example, the learned value ΔVafmaxlv is larger than or equal to the predetermined value ΔVafmaxlvl), an actual, air-fuel ratio (actual AF) presumably does not deviate toward a lean side by a large amount with respect to the target air-fuel ratio AF* even when air-fuel ratio feedback control is started. In addition, the start air-fuel ratio AFst is set on. the basis of the learned value ΔVafmaxlv (how the actual air-fuel ratio (actual AF) easily deviates from the detected air-fuel ratio AFdet) of the responsiveness of the air-fuel ratio sensor 135a, and is set to a value by which an actual air-feel ratio (actual AF) presumably does not deviate toward a lean side by a large amount with respect to the target air-fuel ratio AF* even when air-fuel ratio feedback control is started. Thus, by setting the start air-fuel ratio AFst on the basis of the learned value ΔVafmaxlv, it is possible to start air-fuel ratio feedback control at further appropriate timing, Note that, by setting the start air-fuel ratio AFst so as to be richer than the target air-fuel ratio AF* and so as to increase (so as to approach the target, air-fuel ratio AF*) as the learned value ΔVafmaxlv reduces, the timing at which air-fuel ratio feedback control is started tends to be delayed as the learned value ΔVafmaxlv reduces.

With the above-described, hybrid vehicle 20 according to the embodiment, the learned value ΔVafmaxlv of the responsiveness of the air-fuel ratio sensor 135a is calculated using the maximum slope value ΔVafmax on the basis of the slope value ΔVaf of the output voltage Vaf of the air-fuel ratio sensor 135a at the time when the engine 22 is being cranked, so it is possible to further appropriately team the responsiveness of the air-fuel ratio sensor 135a with a relatively large number of opportunities.

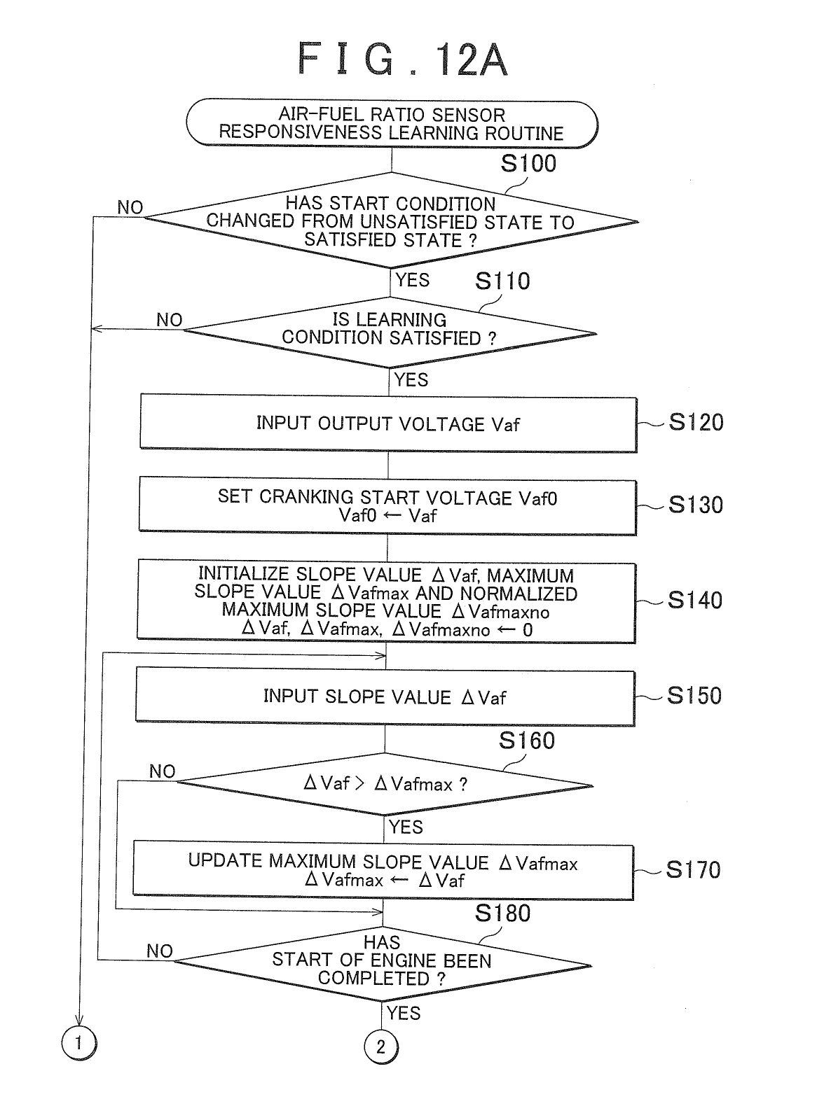

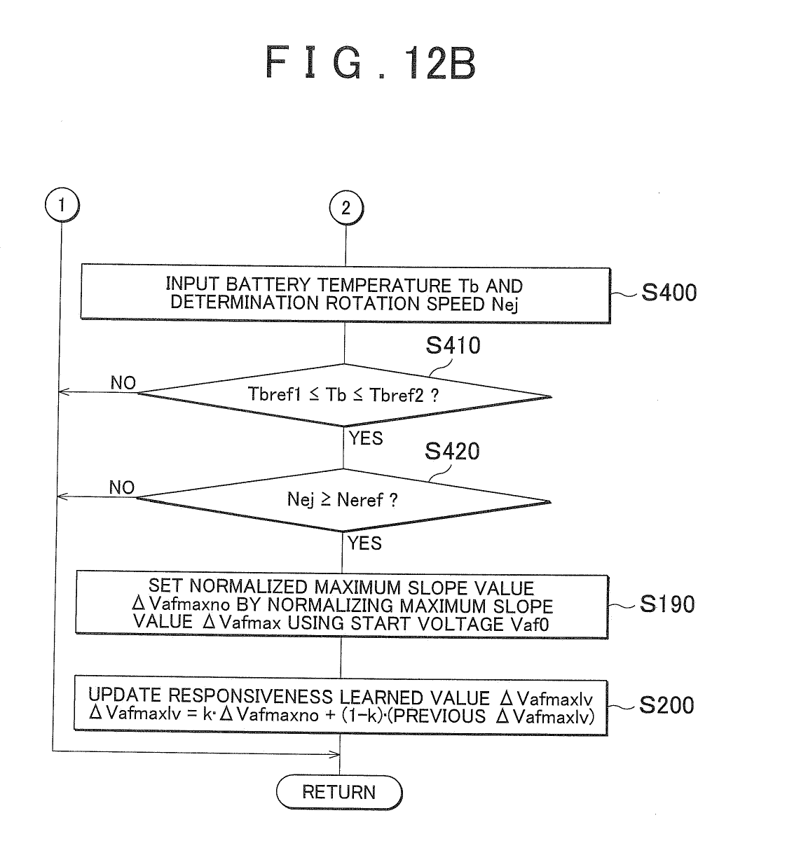

In the hybrid vehicle 20 according to the embodiment, the responsiveness of the air-fuel ratio sensor 135a is learned when the engine 22 is cranked. Instead, the responsiveness of the air-fuel ratio sensor 135a may not be learned depending on a situation at the time when the engine 22 is cranked. FIG. 12 shows an example of the air-fuel ratio sensor responsiveness learning routine in this case. The routine is similar to the air-fuel ratio sensor responsiveness learning routine shown in FIG. 6 except that the processes of steps S400 to S420 are added. Thus, like step numbers denote the same processes, and the detailed description thereof is omitted.

In the air-fuel ratio sensor responsiveness learning routine shown in FIG. 12, when it is determined in step S180 that a start of the engine 22 has been completed (when cranking of the engine 22 has been finished), the battery temperature Tb of the battery 50 and a determination rotation speed Nej, which is the rotation speed No of the engine 22 at the time when the engine 22 has rotated one revolution after the motor MG1 starts cranking the engine 22, are input (step S400), the battery temperature Tb of the battery 50 is compared with thresholds Tbref1 and Tbre2 (step S410), and the determination rotation speed Nej of the engine 22 is compared with a threshold Neref (step S420). Here, the temperature detected by the temperature sensor 51 is input from the battery ECU 52 via the HVECU 70 as the battery temperature Tb of the battery 50. In the embodiment, the determination rotation speed Nej of the engine 22, which is computed on the basis of the crank position from the crank position sensor 140, is loaded and input.

As described above, at the time of a start of the engine 22, the engine 22 is cranked by outputting the cranking torque Te from the motor MG1 and outputting the torque from the motor MG2 to cancel the torque that acts on the drive shaft 36 as a result of the output of the cranking torque Te within the range of the input/output limits Win and Wout of the battery 50. When the battery temperature Tb is lower or higher than an appropriate temperature range, the output limit Wout of the battery 50 is relatively small, so the cranking torque Tc is relatively small, and the rising of the rotation speed Ne of the engine 22 is slow (an increase in the rotation speed Ne is gentle). The thresholds Tbref1 and Tbrerf2 and the threshold Neref are used to determine whether it is in such a situation. The threshold Tbref1 may be, for example, a temperature that is slightly lower than the above-described predetermined temperature Tblo (for example, 0° C., 5° C., 10° C., or the like). In addition, the threshold Tbref2 may be, for example, a temperature that is slightly higher than the above-described predetermined temperature Tbhi (for example, 45° C., 50° C., 55° C., or the like). Furthermore, the threshold Neref may be, for example, 300 rpm, 400 rpm, 500 rpm, or the like.

When the battery temperature Tb is higher than, or equal to the threshold Tbref1 and lower than or equal to the threshold Tbref2 and the determination rotation speed Nej of the engine 22 is higher than or equal to the threshold Neref, as in the case of the embodiment the normalized maximum slope value ΔVafmaxno is set by normalizing, the maximum slope value ΔVafmax (step S190) and the learned value ΔVafmaxlv of the responsiveness of the air-fuel ratio sensor 135a is set using the set normalised maximum slope value ΔVafmaxno (step S200), after which the routine is ended. In this case, the responsiveness of the air-fuel ratio sensor 133a is learned.

On the other hand, when the battery temperature Tb is lower than the threshold Tbref1 or higher than the threshold Thref2 or when the determination rotation speed Nej of the engine 22 is lower than the threshold Neref the routine is ended without executing the processes of steps S190 and S200. In this case, the responsiveness of the air-fuel ratio sensor 135a is not learned.

When the cranking torque Tc is small and the rising of the rotation speed Ne of the engine 22 is slow (an increase in the rotation speed Ne is gentle), the amount of emission, from the engine 22 is small, so a variation in the output voltage Vaf of the air-feel ratio sensor 135a toward a lean-side value slows down, and the maximum slope value ΔVafmax reduces, Therefore, when the responsiveness of the air-fuel ratio sensor 135a is learned using the maximum slope value ΔVafmax at this time, the learned value ΔVafmaxlv may tend to vary. In this alternative embodiment, in consideration of this point, when the battery temperature Tb is lower than the threshold Tbref1 or higher than the threshold Tbref1 or when, the determination rotation speed Nej of the engine 22 is lower than the threshold Neref, the responsiveness of the air-fuel ratio sensor 135a is not learned. By so doing, it is possible to suppress variations in the learned value ΔVafmaxlv.

According to the alternative embodiment, when the battery temperature Tb is lower than the threshold Tbref1 or higher than the threshold Tbref2 or when the determination rotation speed Nej of the engine 22 is lower than the threshold Neref, the responsiveness of the air-fuel ratio sensor 135a is not learned, so it is possible to suppress variations in the learned value ΔVafmaxlv.

In the alternative embodiment, it is determined whether to learn the responsiveness of the air-fuel, ratio sensor 155a using the battery temperature Tb and the determination rotation speed Nej of the engine 22. Instead, it may be determined whether to learn the responsiveness of the air-fuel ratio sensor 135a using only one of them.

In the alternative embodiment, when the battery temperature Tb is lower than the threshold Tbref1 or higher than the threshold Tbref2, the responsiveness of the air-fuel ratio sensor 135a is not learned. Instead, when the cranking torque Tc (torque that is set within the range up to the output limit Wout of the battery 50) is limited to below the threshold Teref the responsiveness of the air-fuel ratio sensor 135a may not be learned. Here, the threshold Teref may be, for example, a torque, that corresponds to the output limit Wout of the battery 50 at the time when the battery temperature Tb is the threshold Tbref1 or the threshold Tbre2.

Furthermore, in the alternative embodiment, when the determination rotation speed Nej of the engine 22 (the rotation speed Ne of the engine 22 at the time when the engine 22 has rotated one revolution after the motor MG1 starts cranking the engine 22) is lower than the threshold Neref, the responsiveness of the air-fuel ratio sensor 135a is not learned. Instead, the responsiveness of the air-fuel ratio sensor 135a may not be learned when, a rate of increase (an amount of increase per unit time) ΔNe in the rotation speed Ne of the engine 22 is lower than the threshold ΔNeref or the responsiveness of the air-fuel ratio sensor 135a may not be learned when a period of time tst that is required for the rotation speed Ne of the engine 22 to reach the threshold. Neref is longer than a threshold tstref. Here, the threshold ΔNeref and the threshold, tstref each may be a value corresponding to the threshold Neref, or the like.

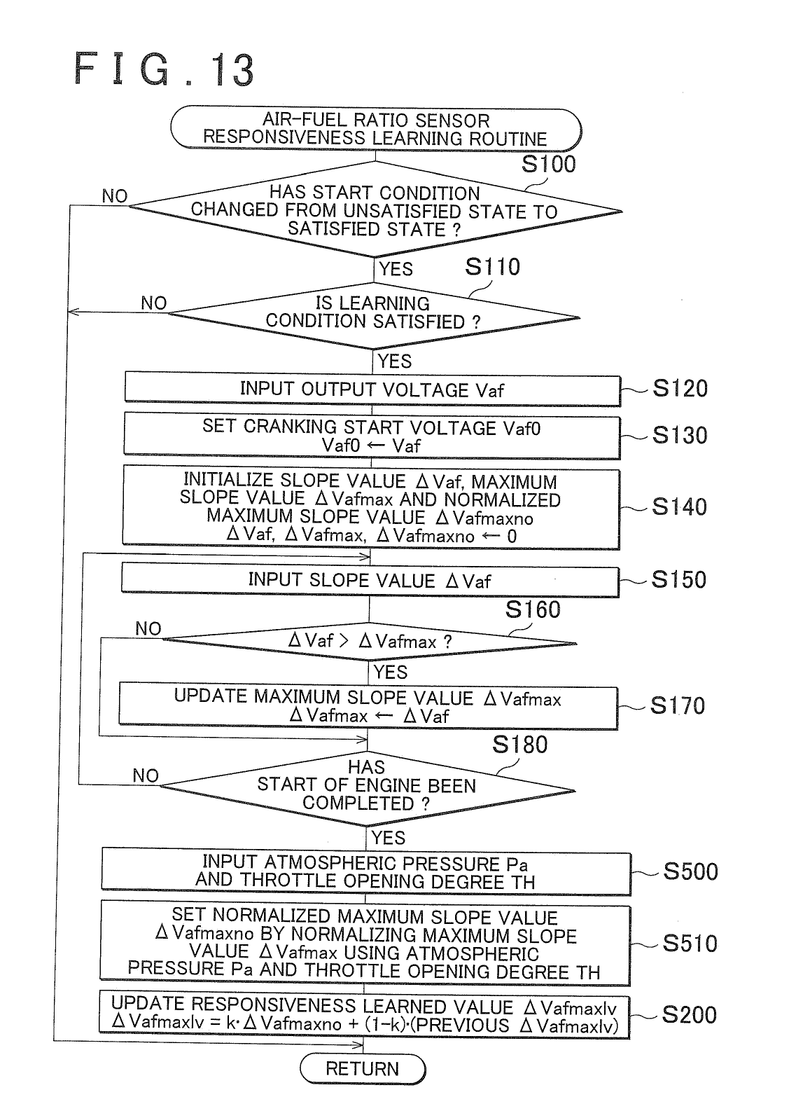

In the hybrid vehicle 20 according to the embodiment, the normalized maximum slope value ΔVafmaxno is set by normalizing the maximum slope value ΔVafmax using the start voltage Vaf0. The normalized maximum slope value ΔVafmaxno may be set by normalizing the maximum slope value ΔVafmax using one or more parameters (such as the atmospheric pressure Pa, the throttle opening degree TH and the intake air temperature Tin) other than the start voltage Vaf0, instead of or in addition to the start voltage Vaf0. FIG. 13 shows an example of the air-fuel ratio sensor responsiveness learning routine in the case where the normalized maximum slope value ΔVafmaxno is set by normalizing the maximum slope value ΔVafmax using the atmospheric pressure Pa and the throttle opening degree TH instead of the start voltage Vaf0. The routine is similar to the air-fuel ratio sensor responsiveness learning routine shown in FIG. 6 except that the processes of steps S500 and S510 are executed instead of the process of step S190. Thus, like step numbers denote the same processes, and the detailed description thereof is omitted.

In the air-fuel ratio sensor responsiveness learning routine shown in FIG. 13, when it is determined in step S180 that a start of the engine 22 has been completed (when cranking of the engine 22 has been finished), the atmospheric pressure Pa that is detected by the atmospheric pressure sensor 89 and received from the HVECU 70 and the throttle opening degree TH from the throttle valve position sensor 14b are input (step S500), the normalized maximum slope value ΔVafmaxno is set by normalizing the maximum slope value ΔVafmax using the input atmospheric pressure Pa and throttle opening degree TH (step S510), and the learned value ΔVafmaxlv of the responsiveness of the air-fuel ratio sensor 135a is set using the set normalised maximum slope value ΔVafmaxno (step S200), after which the routine is ended.

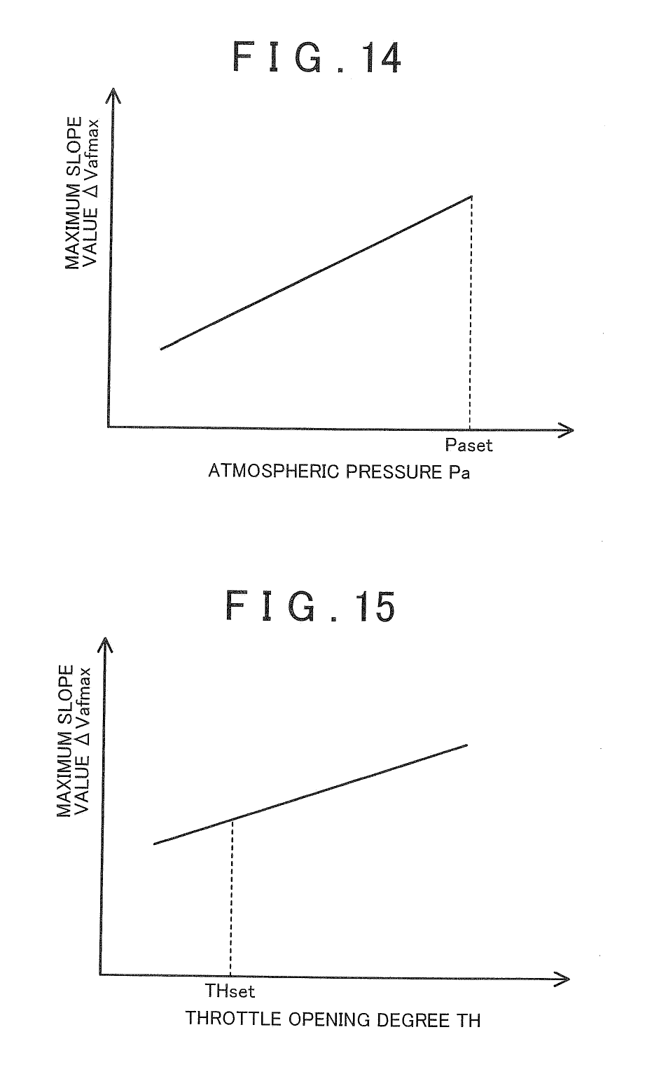

In the embodiment, setting of the normalized maximum slope value ΔVafmaxno in step S510 is performed by normalizing (converting) the maximum slope value ΔVafmax using the atmospheric pressure Pa and the throttle opening degree TH into the maximum slope value ΔVafmax at a predetermined atmospheric pressure (for example, 1 atmospheric pressure, or the like) Paset and a predetermined, opening degree (for example, the above-described basic opening degree THtmp, or the like) THset. FIG. 14 is a graph that shows an example of a correlation line that shows the correlation between an atmospheric pressure Pa and a maximum slope value ΔVafmax. FIG. 15 is a view that shows an example of a correlation line that shows the correlation between a throttle opening degree TH and a maximum slope value ΔVafmax. Hereinafter, a maximum slope value corresponding to the atmospheric pressure Pa in the correlation line between an atmospheric pressure Pa and a maximum slope value ΔVafmax is denoted by “ΔVafmax[Pa]”, and a maximum slope value corresponding to the throttle opening degree TH in a correlation line between a throttle opening degree TH and a maximum slope value ΔVafmax is denoted by “ΔVafmaxf[TH]”. It is possible to obtain the correlation lines shown in FIG. 14 and FIG. 15 similarly to the correlation line of FIG. 7. As is apparent from FIG. 14 and FIG. 15, the air-fuel ratio sensor 135a has such a characteristic that the maximum slope value ΔVafmax varies on the basis of the atmospheric pressure Pa and the throttle opening degree TH. Specifically, the air-fuel ratio sensor 135a has such a characteristic that the maximum, slope value ΔVafmax reduces as the atmospheric pressure Pa reduces and the maximum slope value ΔVafmax reduces as the throttle opening degree TH reduces. In consideration of the characteristics, in this alternative embodiment, tire normalized maximum slope value ΔVafmaxno is calculated by multiplying the maximum slope value ΔVafmax by a correction coefficient Kpa and a correction Kth. The correction coefficient Kpa is obtained by dividing a maximum slope value ΔVafmaxf[Paset] corresponding in the predetermined atmospheric pressure Paset in the correlation line shown in FIG. 14 by a maximum slope value ΔVafmaxf[Pa] corresponding to the atmospheric pressure Pa. The correction coefficient Kth is obtained by dividing a maximum, slope value ΔVafmaxf[THset] corresponding to the predetermined opening degree THset in the correlation line shown in FIG. 15 by a maximum slope value ΔVafmaxf[TH] corresponding to the throttle opening degree TH. Through the above process, it is possible to make it easy to utilize data (normalized maximum slope value ΔVafmaxno) as in the case of the above embodiment.

In the hybrid vehicle 20 according to the embodiment, the normalized maximum slope value ΔVafmaxno is set by normalizing the maximum slope value ΔVafmax at the time when the engine 22 is being cranked, and the learned value ΔVafmaxlv of the responsiveness of the air-fuel ratio sensor 135a is calculated using the set normalized maximum slope value ΔVafmaxno. Instead, for example, a learned value ΔVafmaxlv[Vaf0] may be set in association with the start voltage Vaf0 and the maximum slope value ΔVafmax without normalizing the maximum slope value ΔVafmax.

In the hybrid vehicle 20 according to the above embodiment, the learned value ΔVafmaxlv is calculated through the above-described mathematical expression (3) using the normalized maximum slope value ΔVafmaxno, the previous learned value (previous ΔVafmaxlv) of the responsiveness of the air-fuel ratio sensor 135a and the reflecting coefficient kv. Instead, the normalised maximum slope value ΔVafmaxno may be directly set for the learned value ΔVafmaxlv.

In the hybrid vehicle 20 according to the embodiment, the learned value ΔVafmaxlv of the responsiveness of the air-fuel ratio sensor 135a is used to set the start timing of air-fuel ratio feedback control. In addition to or instead of this configuration, for example, the learned value ΔVafmaxlv of the responsiveness of the air-fuel ratio sensor 135a may be used to, for example, set the air-fuel ratio feedback correction amount ΔQf (for examples sot the proportional-term gain k1 or the integral-term gain k2 in the mathematical expression (1) or a limit value that is used to limit the proportional term or the integral term).

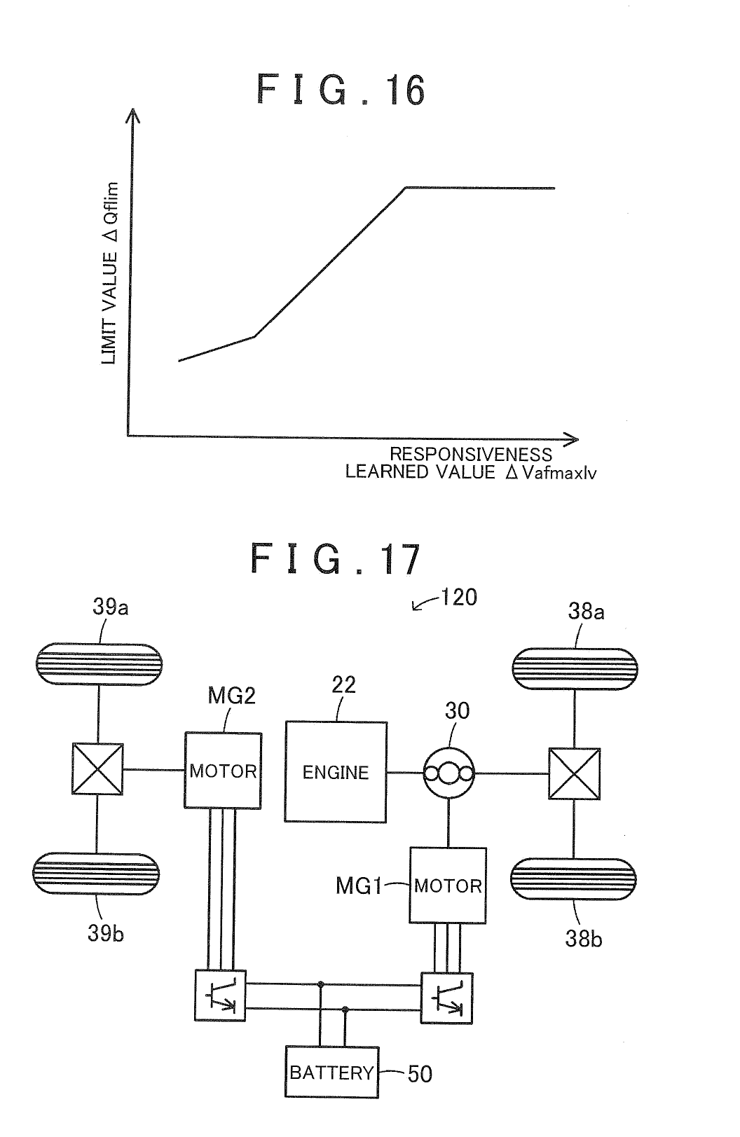

In the hybrid vehicle 20 according to the above embodiment, the air-fuel ratio feedback correction amount ΔQf that is used to set the target fuel, injection amount Qf* is calculated through file above-described mathematical expression (1) using the detected air-fuel ratio AFdet, which corresponds to the output voltage Vaf of the air-fuel ratio sensor 135a, and the target air-fuel ratio AF*. Instead, the air-fuel ratio feedback collection amount ΔQf may be calculated by limiting the integral term in the mathematical expression (1) with limit values ΔQflim and −ΔQflim as shown in the following, mathematical expression (4). In this case, the limit value ΔQflim may be set by applying the learned value ΔVafmaxlv to an integral term, limit value setting map illustrated in FIG. 16, which determines in advance the correlation between a learned value ΔVafmaxlv of the responsiveness of the air-fuel ratio sensor 135a and a limit value ΔQflim. In the example of FIG. 16, the limit value ΔQflim is set so as to reduce as the learned value ΔVafmaxlv reduces. The detected air-fuel ratio AFdet tends to deviate from the target air-fuel ratio AF* when the responsiveness of the air-fuel ratio sensor 135a is low as compared with when the responsiveness is high, and, therefore, the magnitude of the integral term in the mathematical expression (1), that is, the magnitude of the air-fuel ratio feedback correction amount ΔQF presumably tends to increase. Therefore, the integral term in the mathematical expression (1) is limited using the limit value ΔQflim that is set so as to reduce as the learned value ΔVafmaxlv reduces and is used to set the air-fuel ratio feedback correction amount ΔQf. By so doing, it is possible to suppress an excessive increase in the magnitude of the integral term in the mathematical expression (1), that is, the magnitude of the air-fuel ratio feedback, correction amount ΔQf.

ΔQf=k1*(AF*−AF)+max(min(k2·∫(AF*−AF)dt, ΔQflim),−ΔQflim) (4)

In the hybrid vehicle 20 according to the embodiment, power from the motor MG2 is output to the drive shaft 36. Instead, as illustrated in a hybrid vehicle 120 according to an alternative embodiment shown in FIG. 17, power from the motor MG2 may be output to an axle (an axle connected to wheels 39a and 39b in FIG. 17) different from an axle to which the drive shaft 36 is connected (axle to which the drive wheels 38a and 38b are connected),

In the hybrid vehicle 20 according to the embodiment, power from, the engine 22 is output to the drive shaft 36 connected to the drive wheels 38a and 38b via the planetary gear 30, instead, as illustrated in a hybrid, vehicle 220 according to an alternative embodiment shown in FIG. 18, a twin-rotor motor 230 may be provided. The twin-rotor motor 230 includes an inner rotor 232 connected to the crankshaft of the engine 22 and an outer rotor 234 connected to the drive shaft 36 that outputs power to the drive wheels 38a and 38b, and transmits part of the power from the engine 22 to the drive shaft 36 and converts the remaining power to electric power.

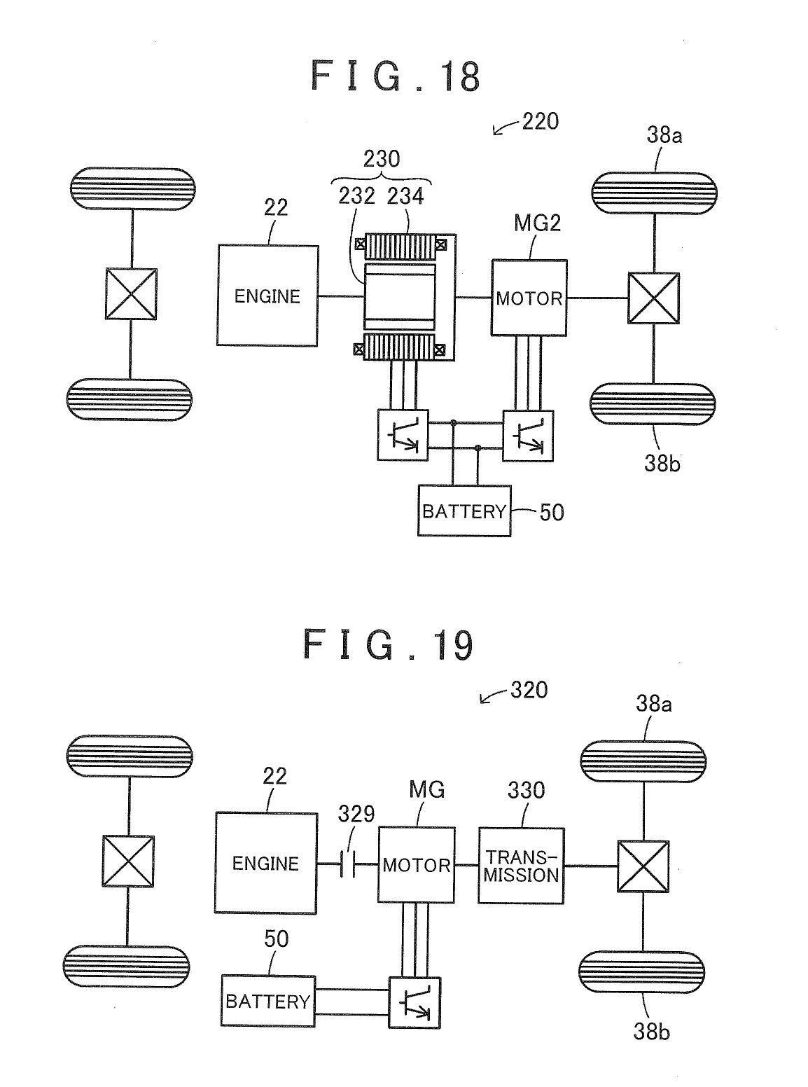

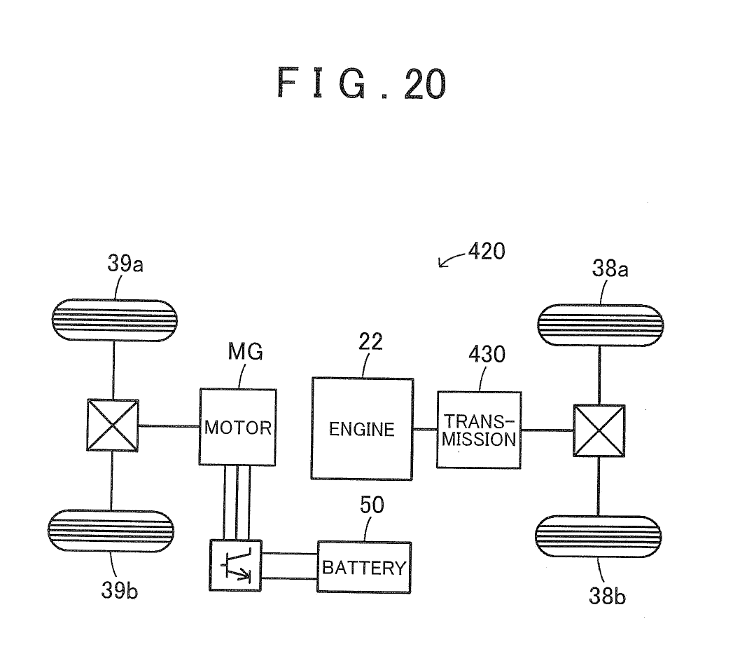

In the hybrid vehicle 20 according to the embodiment power from the engine 22 is output to the drive shaft 36 connected to the drive wheels 38a and 38b via the planetary gear 30. and power from the motor MG2 is output to the drive shaft 36. Instead, as illustrated in a hybrid vehicle 320 according to an alternative embodiment shown in FIG. 19, it is applicable that a motor MG is coupled to the drive shaft 36, connected to the drive wheels 38a and 38b, via a transmission 330 and the engine 22 is connected to a rotary shaft of the motor MG via a clutch 329, power front the engine 22 is output to the drive shaft 36 via the rotary shaft of the motor MG and the transmission 330, and power from the motor MG is output to the drive shaft via the transmission 330. Alternatively, as illustrated in a hybrid vehicle 420 according to an alternative embodiment shown in FIG. 20, it is applicable that power from the engine 22 is output to the drive shaft 36 connected to the drive wheels 38a and 38b via a transmission 430, and power from the motor MG is output to an axle (axle connected to the wheels 39a and 39b in FIG. 20) different from the axle to which the drive wheels 38a and 38b are connected That is, as long as a hybrid vehicle includes an engine and an electric motor that inputs or outputs driving power, a hybrid vehicle of any type may be employed.

Correspondence between the major elements according to the embodiment and the major elements according to the invention will be described. In the embodiment, the engine 22 corresponds to “engine”, the motor MG1 corresponds to “motor”, the battery 50 corresponds to “battery”, the engine ECO 24 that executes the air-fuel ratio sensor responsiveness learning routine, shown in FIG. 6, for calculating the learned value ΔVafmaxlv of the responsiveness of the air-fuel ratio sensor 135a using the maximum slope value ΔVafmax based on the slope value ΔVaf of the output voltage Vaf of the air-fuel ratio sensor 135a at the time when the engine 22 is being cranked, corresponds to “control device”.

Here, the “engine” is not limited to the engine 22 that outputs power using gasoline, light oil, or the like, as-fuel, and may be an engine of any type, such, as a hydrogen engine. The “motor” is not limited to the motor MG1 that is configured as a synchronous motor generator, and may be a motor of any type, such as an induction motor, as long as it is possible to crank the engine. The “battery” is not limited to the battery 50 that is configured as a lithium ion secondary battery; and may be a battery of any type, such as a nickel metal hydride secondary battery, a nickel-cadmium secondary battery and a lead-acid battery, as long as it is possible to exchange electric power with the motor. The “control device” is not limited to the one that calculates the learned value ΔVafmaxlv of the responsiveness of the air-fuel ratio sensor 135a using the maximum slope value ΔVafmax based on the slope value ΔVaf of the output voltage Vaf of the air-fuel ratio sensor 135a at the time when the engine 22 is being cranked., and may be any control device as long as it learns the responsiveness of the air-fuel ratio sensor using the slope of the output value of the air-fuel ratio sensor at the time when the motor is cranking the engine.

Note that the correspondence between the major elements according to the embodiment and the major elements according to the invention is an example in which the embodiment specifically describes a mode for carrying but the invention, so the correspondence does not limit the elements of the invention. That is, interpretation of the invention should be made on the basis of the scope of the invention, and the embodiment is only illustrative.

The mode for carrying out the invention is described using the embodiment; however, the invention is not limited to the above embodiment, and, of course, various modifications are applicable without departing from the scope of the invention.

The invention is usable in, for example, manufacturing industries for a control device for a hybrid vehicle.

What is claimed is:

1. A control device for a hybrid vehicle that includes: an engine; a motor that cranks the engine; a battery that supplies electric power to the motor; and an air-fuel ratio sensor that is attached to an exhaust system of the engine and that changes its output value on the basis of an air-fuel ratio, comprising:
a control unit that is configured to team a responsiveness of the air-fuel ratio sensor using a slope of the output value of the air-fuel ratio sensor at the time when the motor is cranking the engine.

2. The control device according to claim 1, wherein.
the control unit, is configured to normalize a cranking maximum slope value that is a maximum value of the slope of the output value of the air-fuel ratio sensor at the time when the motor is cranking the engine using at least one of the output value of the air-fuel ratio sensor at the time when the motor starts cranking the engine, an atmospheric pressure and a throttle opening degree, and
the control unit is configured to compute a learned value of the responsiveness of the air-fuel ratio sensor using the normalized cranking maximum slope value.

3. The control device according to claim 2, wherein
the control unit is configured to compute the sum of a value, obtained by multiplying the computed normalized, cranking maximum, slope value by a reflecting coefficient larger than 0 and smaller than 1, and a value, obtained by multiplying a previous learned value of the responsiveness of the air-fuel ratio sensor by a value obtained by subtracting the reflecting coefficient from 1, as the learned value of the responsiveness of the air-fuel ratio sensor.

4. The control device according to claim 1, wherein
the control unit is configured not to learn the responsiveness of the air-fuel ratio sensor when a power of the motor is limited to below a threshold or when a rising of a rotation speed of the engine at the time when the motor is cranking the engine is slower than a threshold.

5. The control device according to claim 1, wherein
after a start of the engine, the control unit is configured to set timing at which air-fuel ratio feedback control is started so as to be delayed as the responsiveness of the air-feel ratio sensor decreases.

6. The control device according to claim 5, wherein
the control unit is configured to start air-fuel ratio feedback control after a lapse of a predetermined period of time from a start of the engine and when the output value of the air-fuel, ratio sensor has reached a threshold that is determined so as to be richer than a target air-feel ratio and that approaches the target air-fuel ratio as the responsiveness of the air-fuel ratio sensor decreases or when the output value of the air-fuel ratio sensor has reached a value that is closer to a stoichiometric air-feel ratio than the threshold.

7. The control device according to claim 1, wherein
the control unit is configured to set a limit value of an integral term in air-fuel ratio feedback control so as to reduce as the responsiveness of the air-fuel ratio sensor decreases.

8. The control device according to claim 1, wherein
the air-fuel ratio sensor is a sensor that substantially linearly increases its output value as the air-fuel ratio increases.

9. A control method for a hybrid vehicle that includes: an engine; a motor that cranks the engine; a battery that supplies electric power to the motor; and an air-fuel ratio sensor that is attached to an exhaust system: of the engine and that changes its output value on the basis of an air-fuel ratio, comprising:
learning a responsiveness of the air-fuel ratio sensor using a slope of the output value of the air-fuel ratio sensor at the time when the motor is cranking the engine.

10. The control method according to claim 9, wherein
a cranking maximum slope value that is a maximum value of the slope of the output value of the air-fuel ratio sensor at the time when the motor is cranking the engine is normalized using at least one of the output value of the air-fuel ratio sensor at the time when the motor starts cranking the engine, an atmospheric pressure and a throttle opening degree, and
a learned value of the responsiveness of the air-fuel ratio sensor is computed using the normalized, cranking maximum slope value,

11. The control method according to claim 10, wherein
the sum of a value, obtained by multiplying the computed normalised cranking maximum slope value by a reflecting coefficient larger than 0 and smaller than 1, and a value, obtained by multiplying a previous learned value of the responsiveness of the air-fuel ratio sensor by a value obtained by subtracting the reflecting coefficient from 1, is computed as the learned value of the responsiveness of the air-fuel ratio sensor.

12. The control method according to claim 9, wherein
the responsiveness of the air-fuel ratio sensor is not learned when a power of the motor is limited to below a threshold or when a rising of a rotation speed of the engine at the time when the motor is cranking the engine is slower than a threshold.

13. The control method according to claim 9, wherein
after a start of the engine, timing at which air-fuel ratio feedback control is started is set so as to be delayed as the responsiveness of the air-fuel ratio sensor decreases.

14. The control method according to claim 13, wherein
air-fuel ratio feedback control is started after a lapse of a predetermined period of time from a start of the engine and when the output, value of the air-fuel, ratio sensor has reached a threshold that is determined so as to be richer than a target air-fuel ratio and that approaches the target air-fuel ratio as the responsiveness of the air-fuel ratio sensor decreases or when the output value of the air-fuel ratio sensor has reached a value that is closer to a stoichiometric air-fuel ratio than the threshold.

15. The control method according to claim 9, wherein
a limit value of an integral term in air-fuel ratio feedback control is set so as to reduce as the responsiveness of the air-fuel ratio sensor decreases.

16. The control method, according to claim 9, wherein
the all-fuel ratio sensor is a sensor that substantially linearly increases its output value as the air-fuel ratio increases.
